(19) United States
(12) Patent Application Publication
(10) Pub. No.: US 2026/0134822 A1
(43) Pub. Date: May 14, 2026

(54) ELECTRONIC DEVICE AND METHOD FOR SELECTIVELY DRIVING LIGHT-EMITTING ELEMENTS OF DISPLAY

(71) Applicant: Samsung Electronics Co., Ltd., Suwon-si (KR)

(72) Inventors: Kiwoo KIM, Suwon-si (KR); Seoungyong PARK, Suwon-si (KR); Yongkoo HER, Suwon-si (KR); Hongkook LEE, Suwon-si (KR); Euntaek JANG, Suwon-si (KR)

(21) Appl. No.: 19/389,943

(22) Filed: Nov. 14, 2025

Related U.S. Application Data
(63) Continuation of application No. PCT/KR2024/003526, filed on Mar. 20, 2024.

(30) Foreign Application Priority Data
May 15, 2023 (KR) 10-2023-0062617

(51) Int. Cl. G09G 3/32

(52) U.S. Cl. CPC G09G 3/32; G09G 2300/0819; G09G 2300/0842; G09G 2300/0861; G09G 2310/08; G09G 2320/06; G09G 2330/023; G09G 2360/16

(57) ABSTRACT

An electronic device may include: a display panel comprising a plurality of sub-pixels; a processor; and a display driving circuit. Each of the plurality of sub-pixels may comprise: a first light-emitting element that emits light in a first mode for low power and second light-emitting elements that emit light in a second mode; a driving transistor; and a switch between the first and second light-emitting elements and the drain of the driving transistor. The display driving circuit may be configured to: receive, from the processor, a signal indicating a mode in which the display driving circuit is driven; allow the first light-emitting element to emit light by using a first path connecting between the first light-emitting element and the driving transistor, in the first mode on the basis of the signal; and allow the second light-emitting elements to emit light by using a second path connecting between the second light emitting elements and the driving transistor, in the second mode on the basis of the signal.

### CROSS-REFERENCE TO RELATED APPLICATIONS

This application is a continuation application of International Application No. PCT/KR2024/003526, filed on Mar. 20, 2024, in the Korean Intellectual Property Receiving Office, and claiming priority to Korean Patent Application No. 10-2023-0062617 filed May 15, 2023, the disclosures of which are all hereby incorporated by reference herein in their entireties.

### TECHNICAL FIELD

Certain example embodiments may relate to an electronic device and/or a method for selectively driving a light-emitting element of a display.

### BACKGROUND ART

An electronic device may include a display. For example, the display may include a plurality of light-emitting elements. For example, the electronic device may display an image provided by a processor of the electronic device on the display based on light emission of the plurality of light-emitting elements.

The above-described information may be provided as a related art for the purpose of helping understanding of the present disclosure. No argument or decision is made as to whether any of the above description may be applied as a prior art related to the present disclosure.

### SUMMARY

An electronic device may include a display panel including a plurality of sub-pixels. The electronic device may include a processor (which may include one or more processors) comprising processing circuitry. The electronic device may include display driver circuitry. Each of the plurality of the sub-pixels may include a first light-emitting element emitting light in a first mode for low power and second light-emitting elements emitting light in a second mode different from the first mode. Each of the plurality of the sub-pixels may include a driving transistor to provide a current to the first light-emitting element and the second light-emitting elements. Each of the plurality of the sub-pixels may include a switch between a drain of the driving transistor and the first light-emitting element and the second light-emitting elements. The display driver circuitry may be configured to receive, from the processor, a signal instructing a mode in which the display driver circuitry drives. The display driver circuitry may be configured to, in the first mode identified based on the signal, control the first light-emitting element to emit light using a first path, which is formed based on the switch, connecting the first light-emitting element to the driving transistor. The display driver circuitry may be configured to, in the second mode identified based on the signal, control the second light-emitting elements to emit light using a second path, which is formed based on the switch, connecting the second light-emitting elements to the driving transistor.

A display panel may include sub-pixels of the display panel. The sub-pixels may include a first light-emitting element. The sub-pixels may include second light-emitting elements. The sub-pixels may include a driving transistor to provide a current to the first light-emitting element and the second light-emitting elements. The sub-pixels may include an emitting control transistor connected, directly or indirectly, to a drain of the driving transistor. The sub-pixels may include a switch including a first transistor and a second transistor. The first transistor may include a first source connected, directly or indirectly, to a drain of the emitting control transistor, a first drain connected, directly or indirectly, to an anode of the first light-emitting element, and a first gate. The second transistor may include a second source connected, directly or indirectly, to the drain of the emitting control transistor, a second drain connected, directly or indirectly, to an anode of each of the second light-emitting elements, and a second gate connected, directly or indirectly, to the first gate. A control signal for driving the switch may be applied to the first gate and the second gate.

### BRIEF DESCRIPTION OF THE DRAWINGS

FIG. 1 is a block diagram of an electronic device in a network environment according to various example embodiments.

FIG. 2 is a block diagram of a display module according to various example embodiments.

FIG. 3A illustrates an example of a compensation circuit including a light-emitting element.

FIG. 3B illustrates an example of a timing diagram indicating driving of compensation circuitry.

FIG. 3C illustrates an example of a graph indicating a difference in luminance in accordance with a driving method of compensation circuitry.

FIG. 4A illustrates an example of a pixel of a display including a micro light emitting diode (micro LED).

FIG. 4B illustrates an example of a graph indicating efficiency of a light-emitting element in accordance with a current.

FIG. 4C illustrates an example of a graph indicating power consumption of a display panel in accordance with maximum luminance.

FIG. 4D illustrates an example of a graph indicating luminance in accordance with the number of light-emitting elements.

FIG. 5 illustrates an example of compensation circuitry for selective driving of a light-emitting element.

FIGS. 6A to 6D illustrate an example of a method of driving selective compensation circuitry in a first mode.

FIGS. 7A to 7D illustrate an example of a method of driving selective compensation circuitry in a second mode.

FIG. 8 illustrates an example of a graph indicating a current applied to light-emitting elements in accordance with a mode.

FIG. 9 illustrates an example of compensation circuitry for selective driving of a light-emitting element.

FIGS. 10A to 10D illustrate an example of a method of driving selective compensation circuitry in a first mode.

FIGS. 11A to 11D illustrate an example of a method of driving selective compensation circuitry in a second mode.

FIG. 12 illustrates an example of a graph indicating a current applied to light-emitting elements in accordance with a mode.

FIG. 13A illustrates an example of a graph indicating luminance compensated based on a compensation capacitor.

FIG. 13B illustrates an example of a graph indicating an anode voltage of a light-emitting element in accordance with the number of light-emitting elements.

FIG. 13C illustrates an example of a timing diagram indicating a luminance deviation generated in accordance with the number of light-emitting elements.

FIGS. 14A to 14C illustrate examples of compensation circuitry including a compensation capacitor.

FIG. 15 illustrates an example of an operation flow for a method of selectively driving a light-emitting element in accordance with an example mode.

### DETAILED DESCRIPTION

Terms used in the present disclosure are used only to describe a specific embodiment, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

A term referring to a component of a device (e.g., a processor, a display, a display panel, a compensation circuit, circuit, and the like), a term for a calculation state (e.g., a step, an operation, or a procedure), a term referring to a signal (e.g., an image, a signal, information, data, and the like), and a term referring to data (e.g., a value, and the like) used in the following description are exemplified for convenience of description. Therefore, the present disclosure is not limited to terms to be described below, and another term having an equivalent technical meaning may be used.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B)

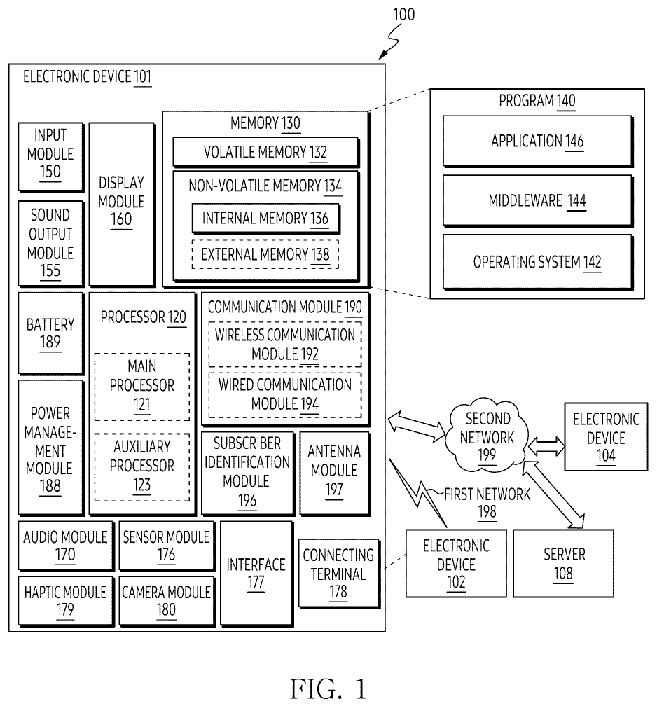

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

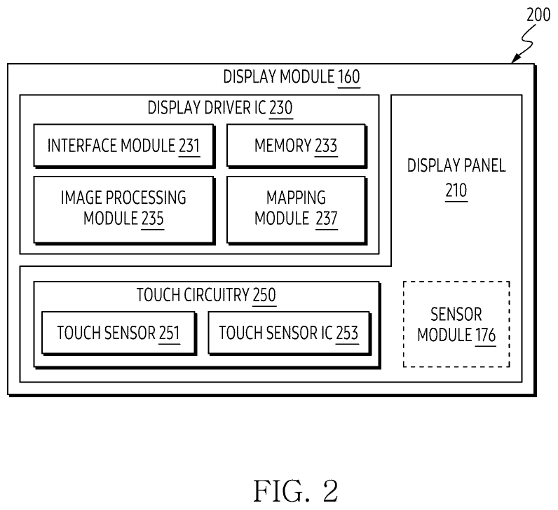

FIG. 2 is a block diagram 200 illustrating the display module 160 according to various embodiments.

Referring to FIG. 2, the display module 160 may include a display panel 210, and a display driver integrated circuit (DDI) 230 to control the display panel 210. The DDI 230 may include an interface module 231, memory 233 (e.g., buffer memory), an image processing module 235, or a mapping module 237. The DDI 230 may receive image information that contains image data or an image control signal corresponding to a command to control the image data from another component of the electronic device 101 via the interface module 231. For example, according to an embodiment, the image information may be received from the processor 120 (e.g., the main processor 121 (e.g., an application processor)) or the auxiliary processor 123 (e.g., a graphics processing unit) operated independently from the function of the main processor 121. The DDI 230 may communicate, for example, with touch circuitry 250 or the sensor module 176 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display panel 210. The mapping module 237 may generate a voltage value or a current value corresponding to the image data pre-processed or post-processed by the image processing module 235. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display panel 210 may be driven, for example, based at least in part on the voltage value or the current value such that visual information (e.g., a text, an image, or an icon) corresponding to the image data may be displayed via the display panel 210.

According to an embodiment, the display module 160 may further include the touch circuitry 250. The touch circuitry 250 may include a touch sensor 251 and a touch sensor IC 253 to control the touch sensor 251. The touch sensor IC 253 may control the touch sensor 251 to sense a touch input or a hovering input with respect to a certain position on the display panel 210. To achieve this, for example, the touch sensor 251 may detect (e.g., measure) a change in a signal (e.g., a voltage, a quantity of light, a resistance, or a quantity of one or more electric charges) corresponding to the certain position on the display panel 210. The touch circuitry 250 may provide input information (e.g., a position, an area, a pressure, or a time) indicative of the touch input or the hovering input detected via the touch sensor 251 to the processor 120. According to an embodiment, at least part (e.g., the touch sensor IC 253) of the touch circuitry 250 may be formed as part of the display panel 210 or the DDI 230, or as part of another component (e.g., the auxiliary processor 123) disposed outside the display module 160.

According to an embodiment, the display module 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display panel 210, the DDI 230, or the touch circuitry 250)) of the display module 160. For example, when the sensor module 176 embedded in the display module 160 includes a biometric sensor (e.g., a fingerprint sensor), the biometric sensor may obtain biometric information (e.g., a fingerprint image) corresponding to a touch input received via a portion of the display panel 210. As another example, when the sensor module 176 embedded in the display module 160 includes a pressure sensor, the pressure sensor may obtain pressure information corresponding to a touch input received via a partial or whole area of the display panel 210. According to an embodiment, the touch sensor 251 or the sensor module 176 may be disposed between pixels in a pixel layer of the display panel 210, or over or under the pixel layer.

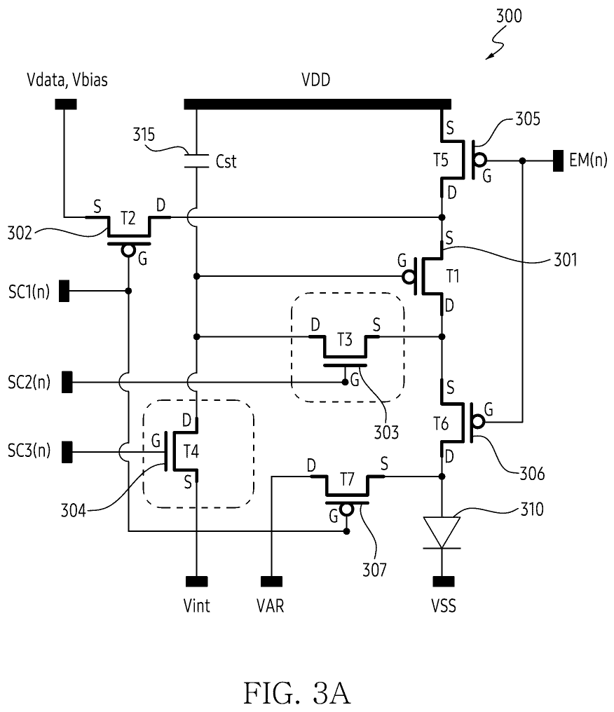

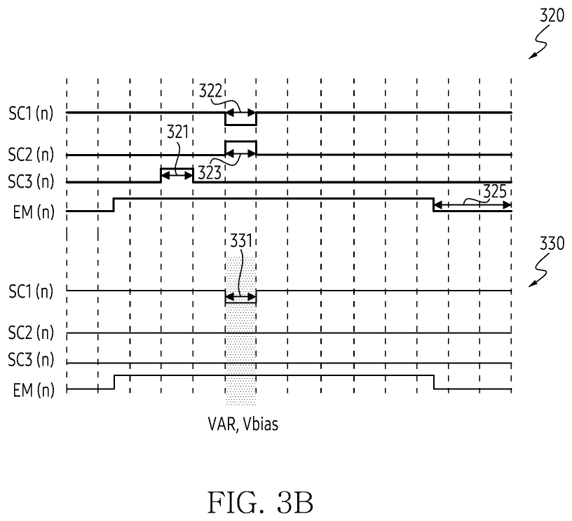

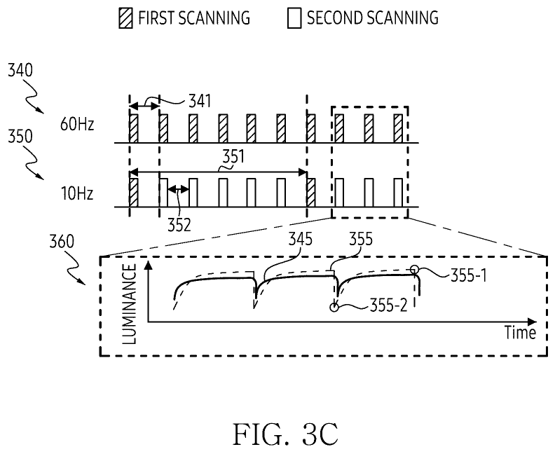

FIG. 3A illustrates an example of a compensation circuit including a light-emitting element.

For example, the compensation circuitry may indicate circuitry for voltage compensation of the light-emitting element included in a sub-pixel. For example, the compensation circuitry may be included in the sub-pixel. For example, a plurality of sub-pixels including the sub-pixel may be included in a display panel (e.g., the display panel 210 of FIG. 2). For example, the light-emitting element may include a light emitting diode (LED).

Referring to FIG. 3A, compensation circuitry 300 may include transistors 301, 302, 303, 304, 305, 306, and 307, a light-emitting element 310, and a capacitor (Cst) 315. For example, the compensation circuitry 300 may include seven transistors 301, 302, 303, 304, 305, 306, and 307 and one capacitor 315. However, the above-described example is merely exemplary for convenience of description, and an embodiment of the present disclosure is not limited thereto. For example, the compensation circuitry may include two transistors and one capacitor.

For example, the compensation circuitry 300 may include the driving transistor 301 (T1), the switching transistor 302 (T2), the compensating transistor 303 (T3), the initiating transistor 304 (T4), the driving control transistor 305 (T5), the emitting control transistor 306 (T6), and the bypassing transistor 307 (T7).

For example, the driving transistor 301 may be a transistor for providing a current to the light-emitting element 310. For example, the driving transistor 301 may provide current to the light-emitting element 310 through a path formed by driving the operation control transistor 305 and the emitting control transistor 306. For example, the current may be identified based on a data voltage (or a bias voltage) provided by switching of the switching transistor 302. For example, the driving transistor 301 may include a source S connected, directly or indirectly, to a drain D of the operation control transistor 305 and a drain D of the switching transistor 302. For example, the driving transistor 301 may include a drain D connected, directly or indirectly, to a source S of the compensating transistor 303 and a source S of the emitting control transistor 306. For example, the driving transistor 301 may include a gate G connected, directly or indirectly, to a capacitor 315, a drain D of the compensating transistor 303, and a drain D of the initiating transistor 304. Each of the source S, the drain D, and the gate G may indicate a terminal (or an electrode) of a transistor. For example, the driving transistor 301 may include a P-type metal oxide semiconductor (PMOS) thin film transistor (TFT).

For example, the switching transistor 302 may be a transistor for providing a data voltage Vdata or a bias voltage Vbias. For example, the switching transistor 302 may be driven based on a scan signal SC1. For example, the data voltage Vdata may indicate data processed by DDI (e.g., the DDI 230 of FIG. 2) to display an image obtained from a processor (e.g., the processor 120 of FIG. 1). For example, the bias voltage Vbias may indicate a voltage used when scanning is used in a mode for low power. Specific content related to this is described in FIG. 3B below. For example, the switching transistor 302 may include a source S to which the data voltage and the bias voltage are applied. For example, the switching transistor 302 may include a drain D connected, directly or indirectly, to the drain D of the operation control transistor 305 and the source S of the driving transistor. For example, the switching transistor 302 may include a gate G, to which the scan signal SC1 is applied, connected, directly or indirectly, to a gate G of the bypassing transistor 307. For example, the switching transistor 302 may include a PMOS TFT.

For example, the compensating transistor 303 may be a transistor for compensating a gate voltage of the driving transistor 301. For example, the data voltage Vdata or the bias voltage Vbias applied through switching of the switching transistor 302 may be transmitted to the compensating transistor 303 through the driving transistor 301. At this time, based on a diode connection, the data voltage or the bias voltage may be provided to the compensating transistor 303 by passing through the driving transistor 301, without a gate voltage applied to the gate G of the driving transistor 301. Accordingly, the gate voltage for the gate G of the driving transistor 301 may be changed to a value that is a sum of the data voltage and a threshold voltage of the driving transistor 301. For example, the compensating transistor 303 may include the source S connected to the drain D of the driving transistor 301 and the source S of the emitting control transistor 306. For example, the compensating transistor 303 may include the drain D connected to the gate G of the driving transistor 301, the capacitor 315, and the drain D of the initiating transistor 304. For example, the compensating transistor 303 may include a gate G to which a scan signal SC2 is applied. For example, the compensating transistor 303 may include an N-type metal oxide semiconductor (NMOS) thin film transistor (TFT).

For example, the initiating transistor 304 may be a transistor for performing voltage initialization. For example, in response to a scan signal SC3 applied to a gate G of the initiating transistor 304, an initiating voltage Vint applied to a source S of the initiating transistor 304 may be provided to the compensation circuitry 300. For example, the initiating transistor 304 may include the source S to which the initiating voltage is applied. For example, the initiating transistor 304 may include the drain D connected to the drain D of the compensating transistor 303, the gate G of the driving transistor 301, and the capacitor 315. For example, the initiating transistor 304 may include the gate G to which the scan signal SC3 is applied. For example, the initiating transistor 304 may include an NMOS TFT.

For example, the driving control transistor 305 may be a transistor for providing a driving voltage VDD. The driving control transistor 305 may be referred to as an emitting control transistor, like the emitting control transistor 306. For example, the driving control transistor 305 may include a source S to which the driving voltage VDD is applied. For example, the driving control transistor 305 may include the drain D connected to the drain D of the switching transistor 302 and the source S of the driving transistor 301. For example, the driving control transistor 305 may include a gate G, to which an emission signal EM is applied, connected to a gate G of emitting control transistor 306. For example, the driving control transistor 305 may include a PMOS TFT.

For example, emitting control transistor 306 may be a transistor that controls the light-emitting element 310 to emit light based on the emission signal EM. For example, as the emission signal EM is applied, a path may be formed between the light-emitting element 310 and a node to which the driving voltage VDD is applied. For example, emitting control transistor 306 may include the source S connected to the drain D of the driving transistor 301 and the source S of the compensating transistor 303. For example, emitting control transistor 306 may include the drain D connected to an anode of the light-emitting element 310 and a source S of the bypassing transistor 307. For example, emitting control transistor 306 may include the gate G, to which the emission signal EM is applied, connected to the gate G of the operation control transistor 305. For example, emitting control transistor 306 may include a PMOS TFT.

For example, the bypassing transistor 307 may be a transistor for bypassing a leakage current among currents provided to the light-emitting element 310. For example, by using the leakage current among the currents provided to the light-emitting element 310 by passing through emitting control transistor 306, contrast at a low current may be improved. For example, the bypassing transistor 307 may include the source S connected to the anode of the light-emitting element 310 and the drain D of emitting control transistor 306. For example, the bypassing transistor 307 may include a drain D connected to a node to which a variable anode reset (VAR) voltage is applied. For example, the bypassing transistor 307 may include the gate G, to which the scan signal SC1 is applied, connected to the gate G of the switching transistor 302. For example, the bypassing transistor 307 may include a PMOS TFT.

For example, the capacitor 315 may be charged based on the data voltage or initialized based on the initiating voltage Vint. For example, the capacitor 315 may be connected to the driving voltage VDD, the gate G of the driving transistor 301, the drain D of the compensating transistor 303, and the drain D of the initiating transistor 304. For example, the capacitor 315 may be referred to as a storage capacitor.

For example, the light-emitting element 310 may emit light based on a current controlled by the driving transistor 301. For example, the light-emitting element 310 may include the anode connected to the drain D of emitting control transistor 306 and the source S of the bypassing transistor 307. For example, the light-emitting element 310 may include a cathode connected to a driving voltage VSS.

The components included in the compensation circuitry 300 of FIG. 3A are exemplary, and an embodiment of the present disclosure is not limited thereto. For example, when using a micro LED as described below, the compensation circuitry 300 may include a plurality of light-emitting elements.

FIG. 3B illustrates an example of a timing diagram indicating driving of compensation circuitry.

Timing diagrams 320 and 330 of FIG. 3B may indicate a method of driving the compensation circuitry 300 of FIG. 3A. In FIG. 3B, for convenience of description, the compensation circuitry 300 of FIG. 3A may be referenced.

The timing diagram 320 may indicate an example in which the compensation circuitry 300 executes a first scan. The timing diagram 330 may indicate an example in which the compensation circuitry 300 executes a second scan. For example, the first scan may be referred to as an address scan. For example, the second scan may be referred to as a self scanning. For example, the address scan may include initializing the gate G of the driving transistor 301, applying a data voltage to the initialized gate G, and providing a current to the light-emitting element 310 through the driving transistor 301 in which the data voltage is applied to the gate G. For example, unlike the address scan, the self scanning may include providing the current to the light-emitting element 310 through the driving transistor 301 from among initializing the gate G, applying the data voltage to the initialized gate G, and providing the current to the light-emitting element 310 through the driving transistor 301.

Referring to the timing diagram 320, for example, the initiating transistor 304 may be driven (or turned on) based on a scan signal SC3 applied in a time interval 321. As the initiating transistor 304 is driven, the gate G of the driving transistor 301 may be initialized. After the time interval 321, the initiating transistor 304 may not be driven. The non-driving may indicate that a transistor in a turned-on state is changed to a turned-off state. For example, the switching transistor 302 may be driven on, based on a scan signal SC1 applied in a time interval 322. For example, the compensating transistor 303 may be driven on, based on a scan signal SC2 applied in a time interval 323. In accordance with the driving of the switching transistor 302 and the compensating transistor 303, the data voltage may be applied to the gate G of the driving transistor 301. The data voltage being applied to the gate G of the driving transistor 301 may be referred to as sampling. After the time interval 322 and the time interval 323, the switching transistor 302 and the compensating transistor 303 may be turned off. For example, the driving control transistor 305 and emitting control transistor 306 may be driven based on an emission signal EM applied in a time interval 325. Accordingly, a current may be provided to the light-emitting element 310 through the driving transistor 301. For example, the current may indicate a current based on the data voltage. For example, the light-emitting element 310 may emit light based on the data voltage. In other words, the light-emitting element 310 may display an image based on the data voltage. “Based on” as used herein covers based at least on.

In contrast, referring to the timing diagram 330, for example, the switching transistor 302 may be driven based on a scan signal SC1 applied in a time interval 331. In addition, the bypassing transistor 307 may be driven based on the scan signal SC1 applied in the time interval 331. Accordingly, the switching transistor 302 may provide a bias voltage to the driving transistor 301, and the bypassing transistor 307 may provide a VAR voltage to an anode of a light-emitting element. The bias voltage may be a voltage for adjusting an element characteristic of the driving transistor 301. The VAR voltage may be a voltage for initializing the anode of the light-emitting element. The driving control transistor 305 and emitting control transistor 306 may be driven based on an emission signal EM applied in a time interval 335. Accordingly, a current may be provided to the light-emitting element 310 through the driving transistor 301. For example, the current may indicate a current based on the bias voltage and the VAR voltage. For example, the light-emitting element 310 may emit light based on the bias voltage and the VAR voltage. In other words, the light-emitting element 310 may display an image based on the bias voltage and the VAR voltage.

Referring to the above description, the first scan of the timing diagram 320 may be executed based on the data voltage obtained from the DDI (e.g., the DDI 230 of FIG. 2). In contrast, the second scan of the timing diagram 330 may be executed based on the bias voltage and the VAR voltage without applying an additional data voltage in a state in which the data voltage stored based on the first scan is at least partially maintained. Since the second scan does not obtain the additional data voltage from the DDI 230, power consumption of the processor 120 (or an electronic device 101) may be less than the first scan. Therefore, the second scan may be used in a mode for low power of a display panel (e.g., the display panel 210). Hereinafter, the mode for low power may be referred to as a first mode. For example, another mode different from the mode for low power may be referred to as a second mode. For example, the second mode may indicate a state in which a power management integrated circuit (PMIC) (e.g., a power management module 188) of the electronic device 101 provides steady state power. For example, the other mode may be referred to as a normal mode or an active state mode.

FIG. 3C illustrates an example of a graph indicating a difference in luminance in accordance with a driving method of compensation circuitry.

FIG. 3C illustrates an example 340 indicating a driving method (e.g., the first scan) of the driving circuitry 300 of FIG. 3A in the second mode, an example 350 indicating a driving method (e.g., the first scan and the second scan) of the driving circuitry 300 in the first mode, and a graph 360 indicating a difference in luminance accordingly.

Referring to FIG. 3C, in the example 340, the compensation circuitry 300 may execute a plurality of first scans in the first mode. For example, the compensation circuitry 300 may execute the plurality of first scans in accordance with a first time interval 341. For example, each of the plurality of first scans may be executed based on the data voltage obtained from the DDI (e.g., the DDI 230). Therefore, the first time interval 341 may be referred to as a frame. For example, a frame rate related to the data voltage provided to the compensation circuitry 300 of the example 340 may be 60 frame per second (FPS). In addition, a refresh rate indicating the number of times the compensation circuitry 300 emits light based on the data voltage may be 60 Hz.

In contrast, in the example 350, the compensation circuitry 300 may execute a plurality of first scans and a plurality of second scans in the second mode. For example, the compensation circuitry 300 may execute the plurality of first scans in accordance with a first time interval 351. Each of the plurality of first scans may be executed based on the data voltage obtained from the DDI (e.g., the DDI 230). Therefore, the first time interval 351 may be referred to as a frame. For example, the compensation circuitry 300 may execute the plurality of second scans in accordance with a second time interval 352. For example, each of the plurality of second scans may be executed based on a bias voltage and a VAR voltage different from the data voltage. The second time interval 352 may be shorter than the first time interval 351. For example, the second time interval 352 may correspond to the first time interval 341. For example, a frame rate related to the data voltage provided to the compensation circuitry 300 of the example 350 may be 10 FPS. In addition, a refresh rate indicating the number of times the compensation circuitry 300 emits light based on the data voltage and the bias voltage may be 60 Hz. In other words, the number of images displayed through the display panel 210 may the same in the example 340 and the example 350, but the number of images provided by the processor 120 to the DDI 230 may be greater in the example 340 than in the example 350.

The graph 360 illustrates a first line 345 indicating luminance in accordance with the first scans and a second line 355 indicating luminance in accordance with the second scans, over time. Referring to the graph 360, even when executed to display the same image, there may be a difference between the luminance in accordance with the first scans and the luminance in accordance with the second scans. For example, a luminance value of a portion 355-1 of the second line 355 may be changed as a bias voltage is changed. For example, a luminance value of a portion 355-2 of the second line 355 may be changed as a VAR voltage is changed. In other words, in order to minimize or reduce the difference, optimization of the bias voltage and the VAR voltage for the second scan may be required.

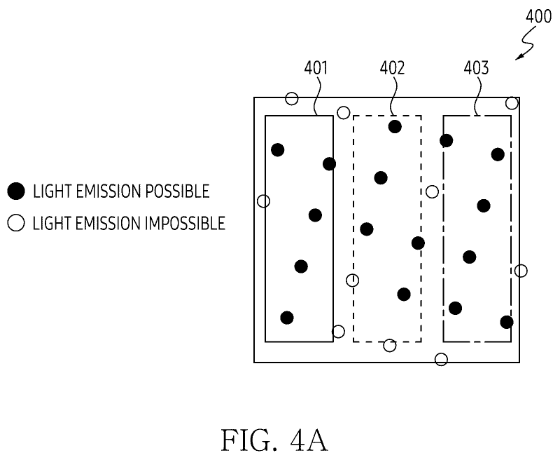

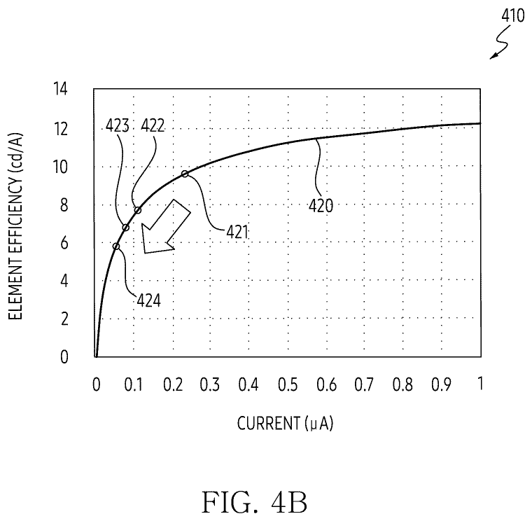

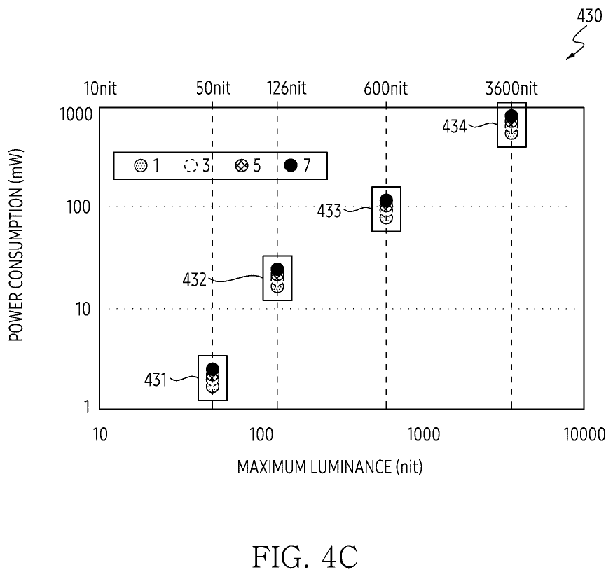

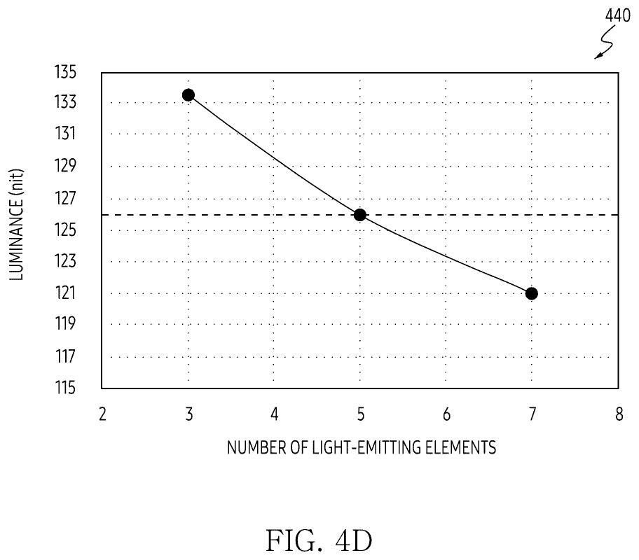

FIG. 4A illustrates an example of a pixel of a display including a micro light emitting diode (micro LED).

Referring to FIG. 4A, an example of a pixel 400 in which the display (e.g., the display panel 210 of FIG. 2) includes a micro LED is illustrated. For example, the pixel 400 may include a plurality of sub-pixels. For example, the pixel 400 may include a sub-pixel 401, a sub-pixel 402, and a sub-pixel 403. For example, a color of the sub-pixel 401 recognized from the outside may be red. For example, a color of the sub-pixel 402 recognized from the outside may be green. For example, a color of the sub-pixel 403 recognized from the outside may be blue.

For example, the pixel 400 may include a plurality of light-emitting elements. For example, the pixel 400 may include 26 micro LEDs. Some of the plurality of micro LEDs may be micro LEDs that may emit light, and the rest may be micro LEDs that may not emit light. For example, five micro LEDs in the sub-pixel 401, five micro LEDs in the sub-pixel 402, and six micro LEDs in the sub-pixel 403 may be micro LEDs that may emit light.

Referring to the above description, in the display including the micro LED, a plurality of light-emitting elements may be disposed in one pixel (or sub-pixel) to improve yield when manufacturing the display. In other words, one compensation circuitry (e.g., the compensation circuitry 300 of FIG. 3A) related to the one sub-pixel may include a plurality of light-emitting elements. However, as the number of light-emitting elements included in the compensation circuitry increases, efficiency of a light-emitting element may decrease, and power consumption may increase. In addition, a luminance deviation between the plurality of light-emitting elements included in the compensation circuitry may occur. Specific content related to this is described in FIGS. 4B to 4C below.

FIG. 4B illustrates an example of a graph indicating efficiency of a light-emitting element in accordance with a current.

FIG. 4B illustrates a graph 410 indicating efficiency of a light-emitting element in accordance with a current in a case that compensation circuitry (e.g., the compensation circuitry 300 of FIG. 3A) includes a plurality of light-emitting elements. In the graph 410, a horizontal axis indicates a current (unit: μA) and a vertical axis indicates efficiency (unit: cd/A).

Referring to the graph 410, a line 420 in which element efficiency increases as a value of a current increases is illustrated. In the line 420, a first point 421, a second point 422, a third point 423, and a fourth point 424 may be points having the same luminance value. For example, the first point 421 may indicate efficiency of a light-emitting element in accordance with a current in a case that one light-emitting element is used. For example, the second point 422 may indicate efficiency of each of the light-emitting elements in accordance with a current in a case that three light-emitting elements are used. For example, the third point 423 may indicate efficiency of each of the light-emitting elements in accordance with a current in a case that five light-emitting elements are used. For example, the fourth point 424 may indicate efficiency of each of the light-emitting elements in accordance with a current in a case that seven light-emitting elements are used. Referring to the first point 421 to the fourth point 424, the efficiency of each of the light-emitting elements may decrease as the number of the light-emitting elements increases.

Referring to the above description, as the number of light-emitting elements in one compensation circuitry increases, a current applied to one light-emitting element may decrease. This is because the light-emitting elements are connected in parallel. At this time, since the element efficiency of each of the light-emitting elements decreases as the number of light-emitting elements increases, a current that should be applied to the light-emitting elements to display specific luminance may be required to have a larger value.

FIG. 4C illustrates an example of a graph indicating power consumption of a display panel in accordance with maximum luminance.

The display panel may include the display panel 210 of FIG. 2. For example, the display panel may include a micro LED. For example, a sub-pixel of the display panel may include at least one light-emitting element.

In FIG. 4C, a graph 430 indicating power consumption of the display panel in accordance with the maximum luminance is illustrated. In the graph 430, a horizontal axis may indicate maximum luminance (unit: nit) and a vertical axis may indicate power consumption (unit: mW).

Referring to the graph 430, the power consumption compared to the maximum luminance in a case that the number of light-emitting elements included in the sub-pixel of the display panel is 1, 3, 5, and 7 is illustrated. In an example 431, when the maximum luminance is approximately 50 nits, the power consumption of the display panel may increase as the number of light-emitting elements increases. In addition, in an example 432, when the maximum luminance is approximately 126 nits, the power consumption of the display panel may increase as the number of light-emitting elements increases. In addition, in an example 433, when the maximum luminance is approximately 600 nits, the power consumption of the display panel may increase as the number of light-emitting elements increases. In addition, in an example 434, when the maximum luminance is approximately 3600 nits, the power consumption of the display panel may increase as the number of light-emitting elements increases. In other words, as the number of light-emitting elements increases, the power consumption of the display panel required to represent the same luminance may increase.

FIG. 4D illustrates an example of a graph indicating luminance in accordance with the number of light-emitting elements.

In FIG. 4D, a graph 440 indicating luminance in accordance with the number of light-emitting elements is illustrated. In the graph 440, a horizontal axis may indicate the number of light-emitting elements, and a vertical axis may indicate luminance (unit: nit).

Referring to the graph 440, in a case that the number of light-emitting elements is 5, luminance in accordance with light emission of the light-emitting elements may be approximately 126 nits. For example, when the number of light-emitting elements is 7, the luminance may be approximately 121 nits. For example, when the number of light-emitting elements is 3, the luminance may be approximately 133 nits.

Referring to the above description, in a case that the number of light-emitting elements included in each of the plurality of sub-pixels in the display panel is different, a deviation in luminance of the display panel may occur. For example, in a case of the sub-pixels 401, 402, and 403 in the pixel 400 of FIG. 4A, the number of light-emitting elements capable of emitting light may be 5, 5, and 6, respectively. Therefore, a luminance deviation may also occur in the pixel 400.

As described above, as maximum luminance required due to technological advances increases, a micro LED may be used as a light-emitting element. For example, an electronic device (or a wearable device) for augmented reality (AR) or virtual reality (VR) may include a display using the micro LED. However, in a case of the micro LED, yield of a light-emitting element may be low when manufacturing a display (or a display panel). The yield may indicate the number of micro LEDs capable of emitting light from among the total number of micro LEDs included in the display. A display panel including a redundant micro LED including a plurality of micro LEDs in one sub-pixel may be used to improve yield. However, as described in FIGS. 4A to 4D, as the number of light-emitting elements included in one sub-pixel increases, power consumption may increase, and a luminance deviation may occur.

Hereinafter, an electronic device and a method according to an embodiment of the present disclosure may include a switch for selecting a light-emitting element for light emission. The electronic device and the method according to an embodiment of the present disclosure may selectively drive the light-emitting element for light emission based on the switch. The electronic device and the method according to an embodiment of the present disclosure may selectively use the light-emitting element based on the switch in accordance with a mode for improving yield and providing maximum luminance (e.g., the second mode) and a mode for low power (e.g., the first mode). In addition, the electronic device and the method according to an embodiment of the present disclosure may improve a luminance deviation by using a compensation capacitor.

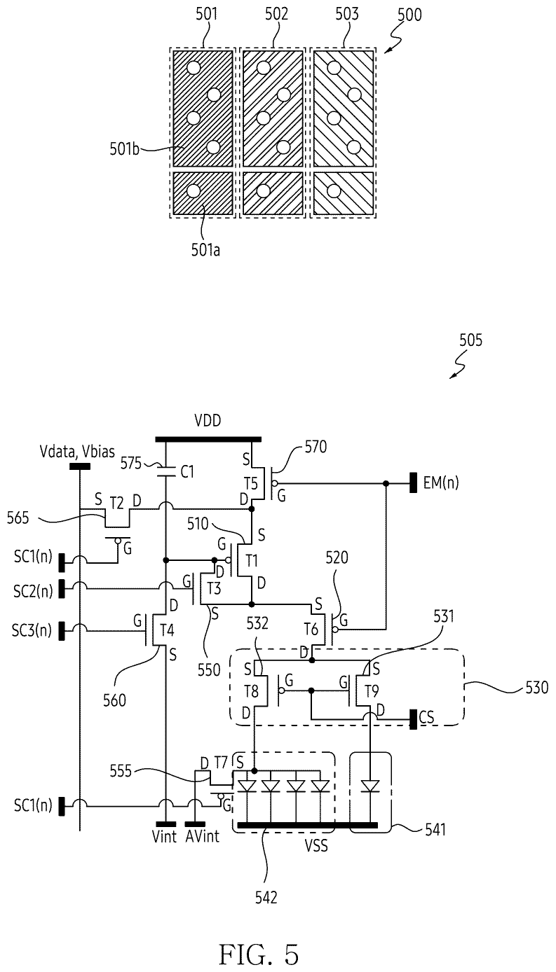

FIG. 5 illustrates an example of compensation circuitry for selective driving of a light-emitting element.

Referring to FIG. 5, one pixel 500 may include a plurality of sub-pixels 501, 502, and 503. For example, each of the plurality of sub-pixels 501, 502, and 503 may include a plurality of light-emitting elements. For example, the first sub-pixel 501 may include five light-emitting elements. For example, the second sub-pixel 502 may include five light-emitting elements. For example, the third sub-pixel 503 may include five light-emitting elements. Light-emitting elements illustrated in the pixel 500 of FIG. 5 may indicate light-emitting elements capable of emitting light. For example, the plurality of light-emitting elements may include a micro LED. However, an embodiment of the present disclosure is not limited thereto, and another type of light-emitting elements may also be applied to an electronic device and a method according to an embodiment of the present disclosure.

Referring to FIG. 5, a plurality of light-emitting elements included in the first sub-pixel 501 in the pixel 500 may include a first light-emitting element 501a for the first mode for low power and at least one second light-emitting element(s) 501b for the second mode different from the first mode.

Referring to FIG. 5, an example of compensation circuitry 505 for the first sub-pixel 501 is illustrated. For example, the compensation circuitry 505 may include a plurality of transistors, a capacitor, and a plurality of light-emitting elements. For example, the compensation circuitry 505 may include a switch 530 including seven transistors 510, 520, 550, 555, 560, 565, 570, and 575 and two transistors 531 and 532. For example, the compensation circuitry 505 may include one capacitor 575 (C1), and a plurality of light-emitting elements 541 and 542. However, the above-described example is merely exemplary for convenience of description, and an embodiment of the present disclosure is not limited thereto.

For example, the compensation circuitry 505 may be included in a display panel 210. For example, the first sub-pixel 501 including the compensation circuitry 505 may be included in the display panel 210. For example, the compensation circuitry 505 may be controlled by the DDI 230 of FIG. 2. For example, scan signals SC1, SC2, and SC3 and a control signal CS applied to the compensation circuitry 505 may be provided from the DDI 230 to the compensation circuitry 505.

For example, the compensation circuitry 505 may include a driving transistor 510 (T1), a switching transistor 565 (T2), a compensating transistor 550 (T3), an initiating transistor 560 (T4), a driving control transistor 570 (T5), an emitting control transistor 520 (T6), and a bypassing transistor 555 (T7).

For example, the driving transistor 510 may be a transistor for providing a current to the light-emitting elements 541 and 542. For example, the driving transistor 510 may provide a current to the light-emitting elements 541 and 542 through a path formed by driving the operation control transistor 570, the emitting control transistor 520, and the switch 530. For example, the current may be identified based on a data voltage (or a bias voltage) provided by switching of the switching transistor 565. For example, the driving transistor 510 may include a source S connected to a drain D of the operation control transistor 570 and a drain D of the switching transistor 565. For example, the driving transistor 510 may include a drain D connected to a source S of the compensating transistor 550 and a source S of the emitting control transistor 520. For example, the driving transistor 510 may include a gate G connected to a capacitor 515, a drain D of the compensating transistor 550, and a drain D of the initiating transistor 560. Each of the source S, the drain D, and the gate G may indicate a terminal (or an electrode) of a transistor. For example, the driving transistor 510 may include a P-type metal oxide semiconductor (PMOS) thin film transistor (TFT).

For example, the switching transistor 565 may be a transistor for providing a data voltage Vdata or a bias voltage Vbias. For example, the switching transistor 565 may be driven based on the scan signal SC1. For example, the data voltage Vdata may indicate data processed by DDI (e.g., the DDI 230 of FIG. 2) to display an image obtained from a processor (e.g., the processor 120 of FIG. 1). For example, the bias voltage Vbias may indicate a voltage used when scanning is used in the first mode for low power. For example, the bias voltage may be a voltage for changing a characteristic of the driving transistor 510. The scanning may include the self scanning or the second scan. For example, the switching transistor 565 may include a source S to which the data voltage Vdata and the bias voltage Vbias are applied. For example, the switching transistor 565 may include a drain D connected to the drain D of the operation control transistor 570 and the source S of the driving transistor. For example, the switching transistor 565 may include a gate G, to which the scan signal SC1 is applied, connected to a gate G of the bypassing transistor 555. For example, the switching transistor 565 may include a PMOS TFT.

For example, the compensating transistor 550 may be a transistor for compensating a gate voltage of the driving transistor 510. For example, the data voltage Vdata or the bias voltage Vbias applied through switching of the switching transistor 565 may be transmitted to the compensating transistor 550 through the driving transistor 510. At this time, based on a diode connection, the data voltage Vdata or the bias voltage Vbias may be provided to the compensating transistor 550 by passing through the driving transistor 510, without a gate voltage applied to the gate G of the driving transistor 510. Accordingly, the gate voltage for the gate G of the driving transistor 510 may be changed to a value that is a sum of the data voltage Vdata and a threshold voltage of the driving transistor 510. For example, the compensating transistor 550 may include the source S connected to the drain D of the driving transistor 510 and the source S of the emitting control transistor 520. For example, the compensating transistor 550 may include the drain D connected to the gate G of the driving transistor 510, the capacitor 515, and the drain D of the initiating transistor 560. For example, the compensating transistor 550 may include a gate G to which the scan signal SC2 is applied. For example, the compensating transistor 550 may include an N-type metal oxide semiconductor (NMOS) thin film transistor (TFT).

For example, the initiating transistor 560 may be a transistor for performing voltage initialization. For example, in response to the scan signal SC3 applied to a gate G of the initiating transistor 560, an initiating voltage Vint applied to a source S of the initiating transistor 560 may be provided to the driving transistor 510. For example, the initiating transistor 560 may include the source S to which the initiating voltage Vint is applied. For example, the initiating transistor 560 may include the drain D connected to the drain D of the compensating transistor 550, the gate G of the driving transistor 510, and the capacitor 315. For example, the initiating transistor 560 may include the gate G to which the scan signal SC3 is applied. For example, the initiating transistor 560 may include an NMOS TFT.

For example, the driving control transistor 570 may be a transistor for providing a driving voltage VDD. The driving control transistor 570 may be referred to as an emitting control transistor, like the emitting control transistor 520. For example, the driving control transistor 570 may include a source S to which the driving voltage VDD is applied. For example, the driving control transistor 570 may include the drain D connected to the drain D of the switching transistor 565 and the source S of the driving transistor 510. For example, the driving control transistor 570 may include a gate G, to which an emission signal EM is applied, connected to a gate G of the emitting control transistor 520. For example, the driving control transistor 570 may include a PMOS TFT.

For example, the emitting control transistor 520 may be a transistor that controls the light-emitting elements 541 and 542 to emit light based on the emission signal EM. For example, as the emission signal EM is applied, a path may be formed between the switch 530 and a node to which the driving voltage VDD is applied. For example, the emitting control transistor 520 may include the source S connected to the drain D of the driving transistor 510 and the source S of the compensating transistor 550. For example, the emitting control transistor 520 may include a drain D connected to the switch 530. For example, the drain D of the emitting control transistor 520 may be connected to a source S of the first transistor 531 and a source S of the second transistor 532 of the switch 530. For example, the emitting control transistor 520 may include the gate G, to which the emission signal EM is applied, connected to the gate G of the operation control transistor 570. For example, the emitting control transistor 520 may include a PMOS TFT.

For example, the bypassing transistor 555 may be a transistor for bypassing a leakage current among currents provided to the second light-emitting elements 542. For example, by using the leakage current among the currents provided to the second light-emitting elements 542 by passing through the emitting control transistor 520, contrast at a low current may be improved. For example, the bypassing transistor 555 may include the source S connected to an anode of each of the second light-emitting elements 542 and the drain D of the emitting control transistor 520. For example, the bypassing transistor 555 may include a drain D connected to a node to which an anode initiating voltage AVint is applied. For example, the bypassing transistor 555 may include the gate G, to which the scan signal SC1 is applied, connected to the gate G of the switching transistor 565. For example, the bypassing transistor 555 may include a PMOS TFT.

For example, the switch 530 may include two transistors. For example, the switch 530 may include the first transistor 531 (T9) driven (or turned on) in the first mode for low power and the second transistor 532 (T8) driven in the second mode different from the first mode. For example, the first transistor 531 may include the source S connected to the drain D of the emitting control transistor 520 and the source S of the second transistor 532. For example, the first transistor 531 may include a drain D connected to an anode of the first light-emitting element 541. For example, the first transistor 531 may include a gate G, to which the control signal CS is applied, connected to a gate G of the second transistor 532. For example, the second transistor 532 may include the source S connected to the drain D of the emitting control transistor 520 and the source S of the first transistor 531. For example, the second transistor 532 may include a drain D connected to the anode of each of the second light-emitting elements 542 and the drain D of the bypassing transistor 555. For example, the second transistor 532 may include a gate G, to which the control signal CS is applied, connected to the gate G of the first transistor 531. The control signal CS may be provided from the DDI (e.g., the DDI 230). For example, the control signal CS may be provided to all sub-pixels in the display panel (e.g., the display panel 210). In other words, the control signal CS may be provided to all lines (or all sub-pixels) other than being provided for each line, such as the scan signals SC1, SC2, and SC3. The line may be referred to as a set of a plurality of sub-pixels triggered by a horizontal synchronization signal or a component connected to the plurality of sub-pixels in the set. For example, the first transistor 531 and the second transistor 532 may be of different types. For example, in a case that the first transistor 531 is a PMOS TFT, the second transistor 532 may be an NMOS TFT. Alternatively, in a case that the first transistor 531 is an NMOS TFT, the second transistor 532 may be a PMOS TFT.

In FIG. 5, an example of the switch 530 to which one control signal is applied is illustrated, but an embodiment of the present disclosure is not limited thereto. For example, the gate G of the first transistor 531 is not connected to the gate G of the second transistor 532, and different control signals may be applied to each of the gate G of the first transistor 531 and the gate G of the second transistor 532.

For example, the capacitor 575 may be charged based on the data voltage Vdata or initialized based on the initiating voltage Vint. For example, the capacitor 575 may be connected to the driving voltage VDD, the gate G of the driving transistor 510, the drain D of the compensating transistor 550, and the drain D of the initiating transistor 560. For example, the capacitor 575 may be referred to as a storage capacitor.

For example, the light-emitting elements 541 and 542 may emit light based on a current controlled by the driving transistor 510. For example, in the first mode, a current may be provided to the first light-emitting element 541 through a path based on the operation control transistor 570 and the emitting control transistor 560 driven by the emission signal EM, the first transistor 531 driven by the control signal CS, and the driving transistor 510. Accordingly, the first light-emitting element 541 may emit light. In addition, for example, in the second mode, a current may be provided to the second light-emitting elements 542 through a path based on the operation control transistor 570 and the emitting control transistor 560 driven by the emission signal EM, the second transistor 532 driven by the control signal CS, and the driving transistor 510. Accordingly, the second light-emitting elements 542 may emit light. For example, the first light-emitting element 541 may include the anode connected to the drain D of the first transistor 531. For example, the first light-emitting element 541 may include a cathode connected to a driving voltage VSS. For example, each of the second light-emitting elements 542 may include the anode connected to the drain D of the second transistor 532. For example, each of the second light-emitting elements 542 may include a cathode connected to the driving voltage VSS.

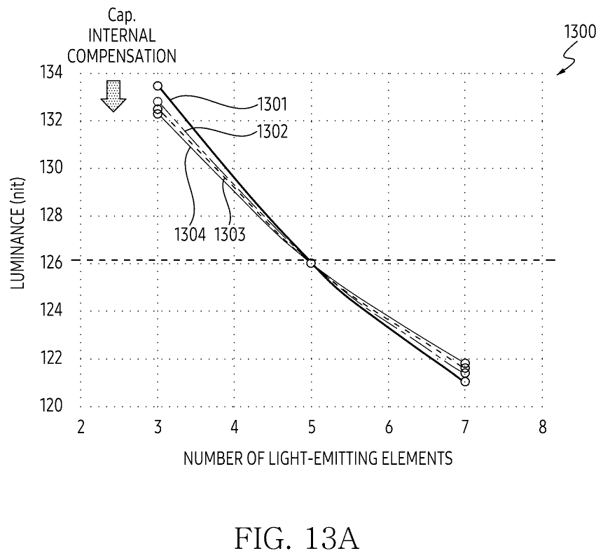

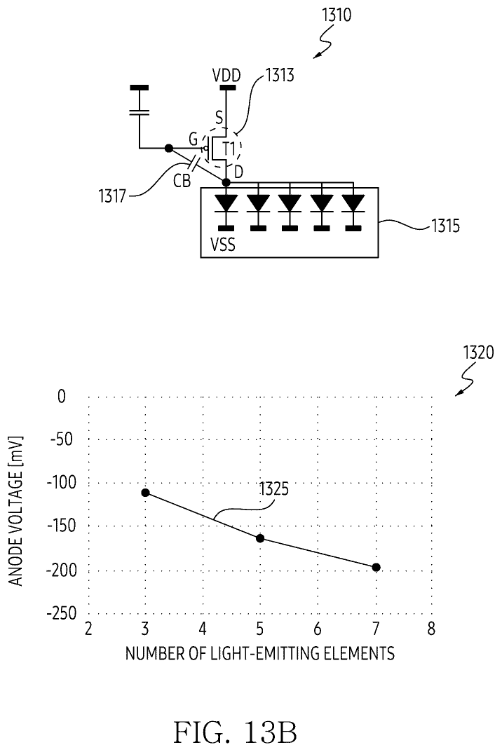

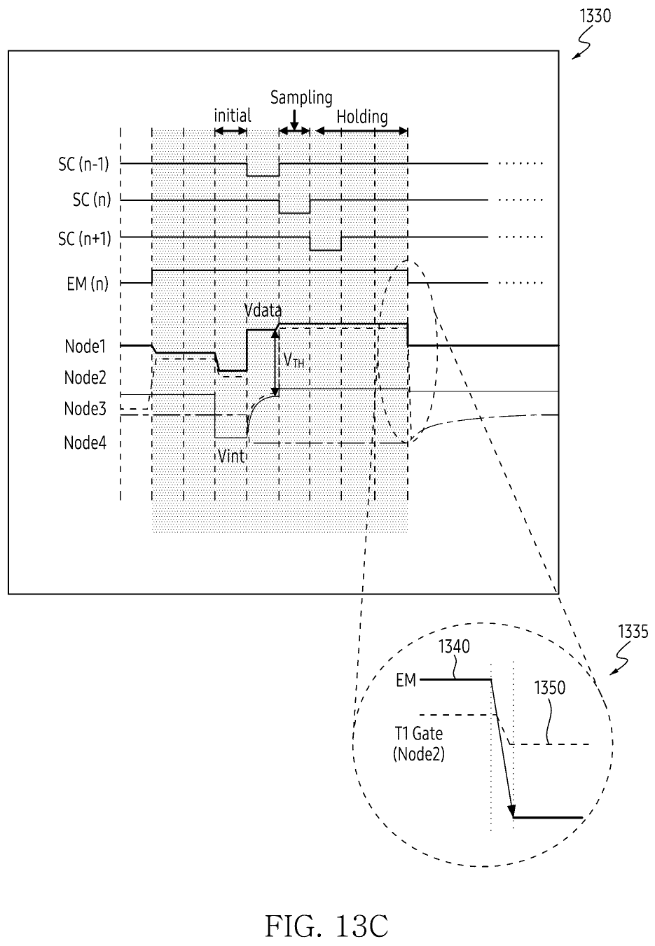

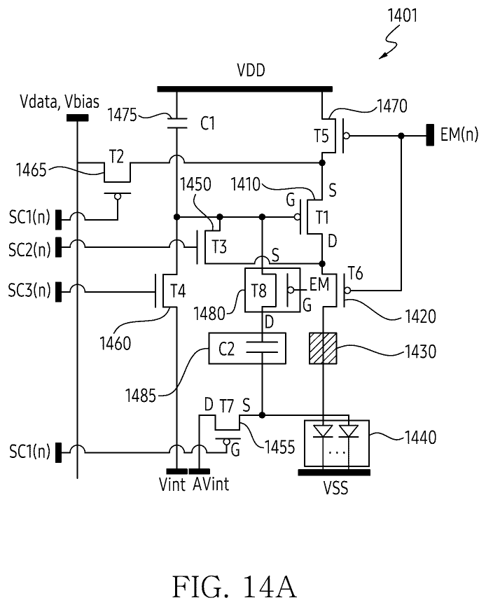

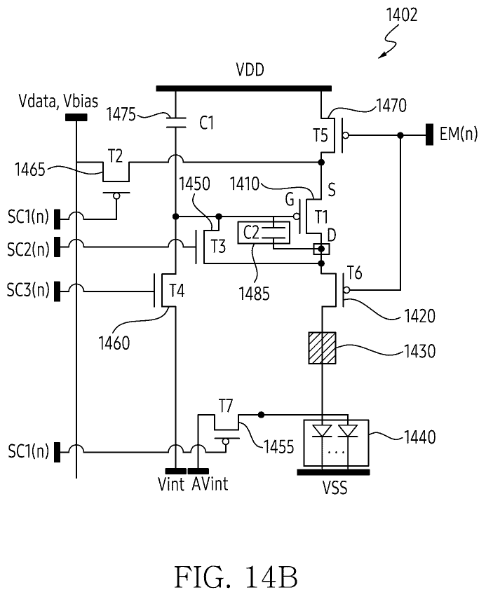

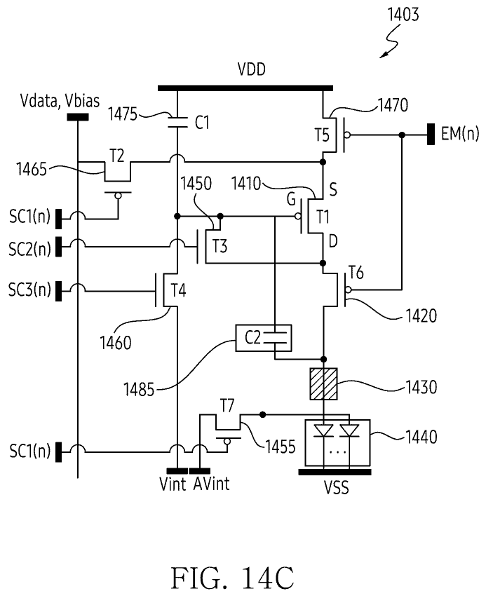

Although not illustrated in FIG. 5, for example, the compensation circuitry 505 may further include a compensation capacitor for improving a luminance deviation. Specific content related to this is described in FIGS. 13A to 14C below.

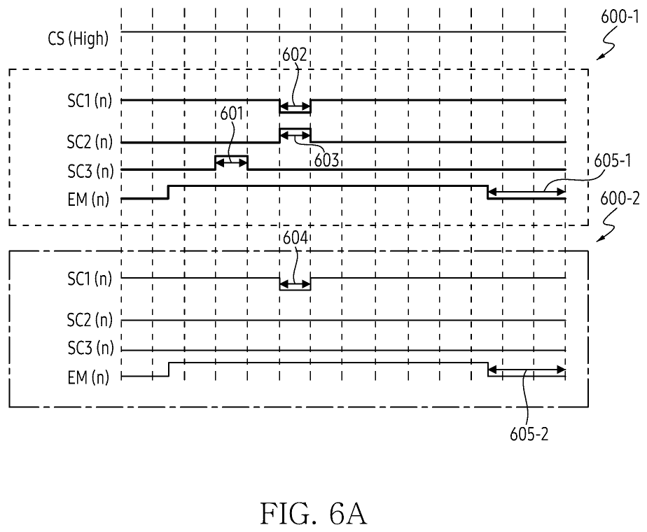

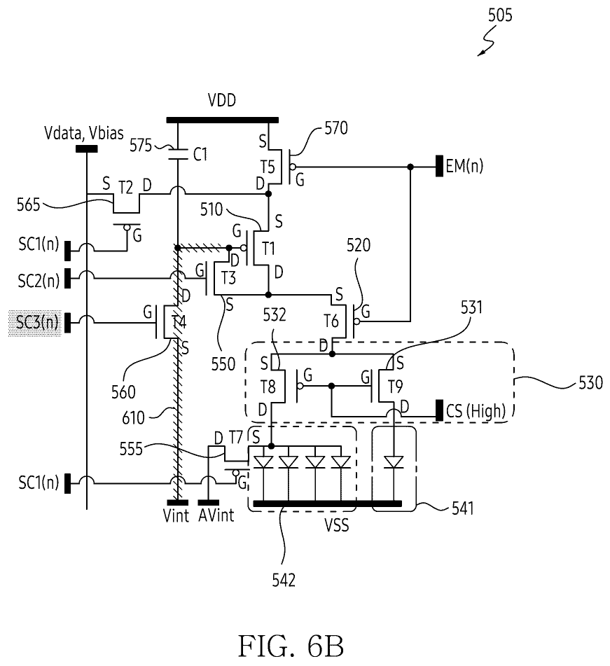

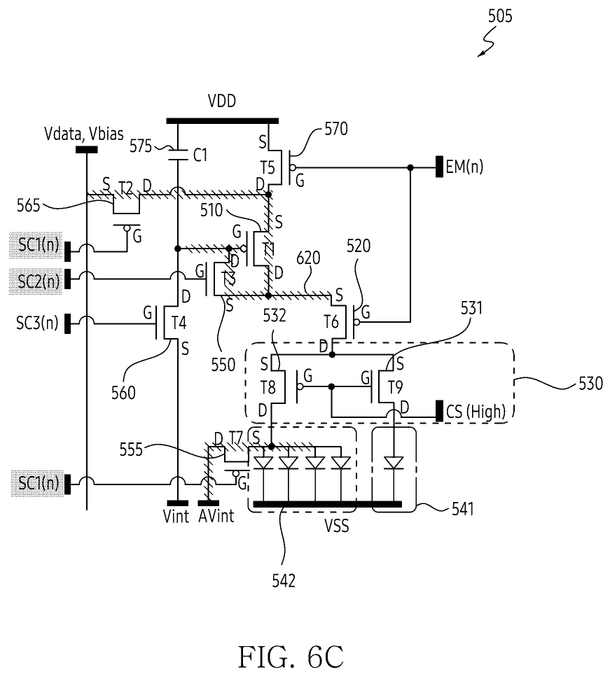

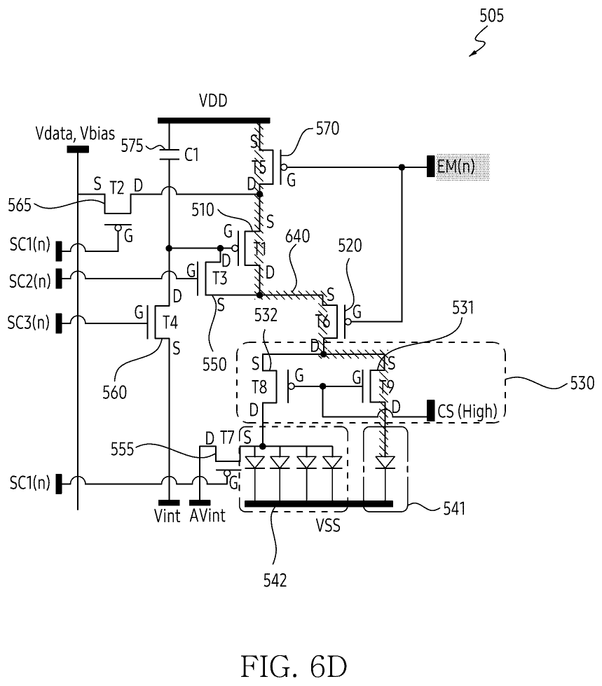

FIGS. 6A to 6D illustrate an example of a method of driving selective compensation circuitry in a first mode.

The selective compensation circuitry may indicate the compensation circuitry 505 of FIG. 5 including a switch 530 for selecting a first light-emitting element 541 for the first mode or second light-emitting elements 542 for the second mode among a plurality of light-emitting elements. For example, the method of FIGS. 6A to 6D may be performed through the compensation circuitry 505 of FIG. 5.

Referring to FIG. 6A, a timing diagram 600-1 exemplifying the first scan performed in the first mode and a timing diagram 600-2 exemplifying the second scan performed in the first mode are illustrated. For example, the first scan may be referred to as an address scan. For example, the second scan may be referred to as a self scanning. For example, the address scan may include initializing a gate of the driving transistor 510, applying a data voltage to the initialized gate, and providing a current to a light-emitting element (e.g., the first light-emitting element 541 or the second light-emitting elements 542) through the driving transistor 510 in which the data voltage is applied to the gate. For example, unlike the address scan, the self scanning may include providing the current to the light-emitting element (e.g., the first light-emitting element 541 or the second light-emitting elements 542) through the driving transistor 510 from among initializing the gate, applying the data voltage to the initialized gate, and providing the current to the light-emitting element (e.g., the first light-emitting element 541 or the second light-emitting elements 542) through the driving transistor 510.

Referring to the timing diagram 600-1 of FIG. 6A, for example, an initiating transistor 560 may be driven (or turned on) based on a scan signal SC3 applied in a time interval 601. The scan signal SC3 being applied may indicate a case in which a voltage of the scan signal SC3 is high. However, an embodiment of the present disclosure is not limited thereto, and the scan signal SC3 may be applied in a case that the voltage of the scan signal SC3 is low in accordance with a transistor to which the voltage is applied.

As the initiating transistor 560 is driven, a gate G of the driving transistor 510 may be initialized. Referring to FIG. 6B, the initiating transistor 560 may be changed from a turn off state to a turn on state based on the scan signal SC3 applied to a gate G of the initiating transistor 560. Through a path 610 formed accordingly, an initiating voltage Vint may be applied to the gate G of the driving transistor 510. The gate G of the driving transistor 510 may be initialized based on the initiating voltage Vint. In other words, a gate voltage of the driving transistor 510 may be changed to the initiating voltage Vint.

Referring to the timing diagram 600-1 of FIG. 6A, for example, since the scan signal SC3 is not applied (or when the voltage of the scan signal SC3 is low) after the time interval 601, the driving of the initiating transistor 560 may be ceased.

Referring to the timing diagram 600-1 of FIG. 6A, for example, a switching transistor 565 may be driven (or turned on) based on a scan signal SC1 applied in a time interval 602. The scan signal SC1 being applied may indicate a case in which a voltage of the scan signal SC1 is low. However, an embodiment of the present disclosure is not limited thereto, and the scan signal SC1 may be applied in a case that the voltage of the scan signal SC1 is high in accordance with a transistor to which the voltage is applied. In addition, a compensating transistor 550 may be driven (or turned on) based on a scan signal SC2 applied in a time interval 603. The scan signal SC2 being applied may indicate a case in which a voltage of the scan signal SC2 is high. However, an embodiment of the present disclosure is not limited thereto, and the scan signal SC2 may be applied in a case that the voltage of the scan signal SC2 is low in accordance with a transistor to which the voltage is applied.

As the switching transistor 565 and the compensating transistor 550 are driven, a data voltage may be provided to the driving transistor 510. Referring to FIG. 6C, the switching transistor 565 may be changed from a turn off state to a turn on state based on the scan signal SC1 applied to a gate G of the switching transistor 565. The compensating transistor 550 may be changed from a turn off state to a turn on state based on the scan signal SC2 applied to a gate G of the compensating transistor 550. Through a path 620 formed accordingly, a data voltage Vdata may be applied to the gate G of the driving transistor 510 by passing through the switching transistor 565 and the compensating transistor 550. In other words, the data voltage Vdata may be applied to the initialized gate G of the driving transistor 510.

Referring to the timing diagram 600-1 of FIG. 6A, for example, since the scan signal SC1 and the scan signal SC3 are not applied after the time interval 602 and the time interval 603, the driving of the switching transistor 565 and the compensating transistor 550 may be ceased.

Referring to the timing diagram 600-1 of FIG. 6A, for example, a driving control transistor 570 and an emitting control transistor 520 may be driven (or turned on) based on an emission signal EM applied in a time interval 605-1. The emission signal EM being applied may indicate a case in which a voltage of the emission signal EM is low. However, an embodiment of the present disclosure is not limited thereto, and the emission signal EM may be applied in a case that the voltage of the emission signal EM is high in accordance with a transistor to which the voltage is applied. In addition, referring to the timing diagram 600-1, a control signal CS may be high in an entire time interval in the first mode. For example, a first transistor 531 of the first transistor 531 and a second transistor 532 may be driven based on the control signal CS having a high voltage applied to the first transistor 531 and the second transistor 532.

As the driving control transistor 570, the emitting control transistor 520, and the first transistor 531 of the switch 530 are driven, the first light-emitting element 541 may emit light. Referring to FIG. 6D, the driving control transistor 570 and the emitting control transistor 520 may be changed from a turn off state to a turn on state based on the emission signal EM applied to a gate G of the driving control transistor 570 and the emitting control transistor 520. The first transistor 531 may be changed from a turn off state to a turn on state based on the control signal CS applied to a gate G of the first transistor 531. Through a path 640 formed accordingly, a current may be applied to the first light-emitting element 541. The first light-emitting element 541 among the first light-emitting element 541 and the second light-emitting elements 542 may emit light through the first transistor 531 of the switch 530 identified by the control signal. In other words, the first light-emitting element 541 selected from among the first light-emitting element 541 and the second light-emitting elements 542 may be driven.

As described above, the first scan executed in the first mode may include initializing a gate, applying a data voltage to the gate, and providing a current to a light-emitting element, as described in FIGS. 6A to 6D. In contrast, the second scan executed in the first mode may be referred to the timing diagram 600-2.

Referring to the timing diagram 600-2 of FIG. 6A, for example, the switching transistor 565 may be driven (or turned on) based on the scan signal SC1 applied in a time interval 604. The scan signal SC1 being applied may indicate a case in which the voltage of the scan signal SC1 is low. However, an embodiment of the present disclosure is not limited thereto, and the scan signal SC1 may also be applied in a case that the voltage of the scan signal SC1 is high in accordance with the transistor to which the voltage is applied.

As the switching transistor 565 is driven, a bias voltage may be provided to the driving transistor 510. Referring to FIG. 6C, the switching transistor 565 may be changed from the turn off state to the turn on state based on the scan signal SC1 applied to the gate G of the switching transistor 565. Through a portion of the path 620 formed accordingly, the bias voltage Vbias may be applied to a source S of the driving transistor 510 and a drain D of the driving transistor 510.

Referring to the timing diagram 600-2 of FIG. 6A, for example, since the scan signal SC1 is not applied after the time interval 604, the driving of the switching transistor 565 may be ceased.

Referring to the timing diagram 600-2 of FIG. 6A, for example, the driving control transistor 570 and the emitting control transistor 520 may be driven (or turned on) based on the emission signal EM applied in a time interval 605-2. The emission signal EM being applied may indicate a case in which the voltage of the emission signal EM is low. However, an embodiment of the present disclosure is not limited thereto, and the emission signal EM may also be applied in a case that the voltage of the emission signal EM is high in accordance with the transistor to which the voltage is applied. In addition, referring to the timing diagram 600-2, the control signal CS may be high in the entire time interval in the first mode. For example, the first transistor 531 of the first transistor 531 and the second transistor 532 may be driven based on the control signal CS having the high voltage applied to the first transistor 531 and the second transistor 532.

As the driving control transistor 570, the emitting control transistor 520, and the first transistor 531 of the switch 530 are driven, the first light-emitting element 541 may emit light. Referring to FIG. 6D, the driving control transistor 570 and the emitting control transistor 520 may be changed from the turn off state to the turn on state based on the emission signal EM applied to the gate G of the driving control transistor 570 and the emitting control transistor 520. The first transistor 531 may be changed from the turn off state to the turn on state based on the control signal CS applied to the gate G of the first transistor 531. Through the path 640 formed accordingly, the current may be applied to the first light-emitting element 541. The first light-emitting element 541 among the first light-emitting element 541 and the second light-emitting elements 542 may emit light through the first transistor 531 of the switch 530 identified by the control signal. In other words, the first light-emitting element 541 selected from among the first light-emitting element 541 and the second light-emitting elements 542 may be driven.

As described above, the second scan executed in the first mode may include providing a current to a light-emitting element based on the bias voltage provided to the driving transistor 510, as described in FIGS. 6C and 6D.

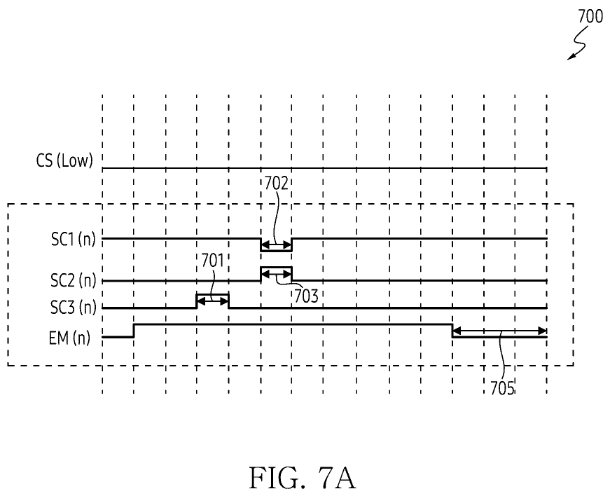

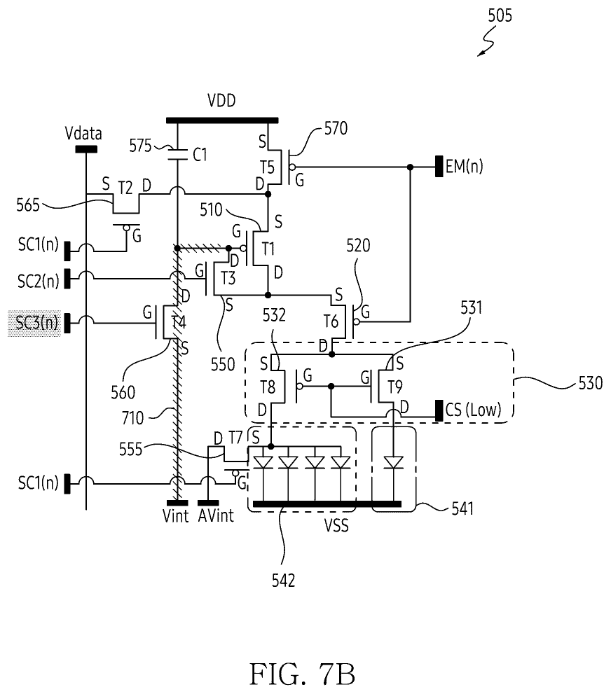

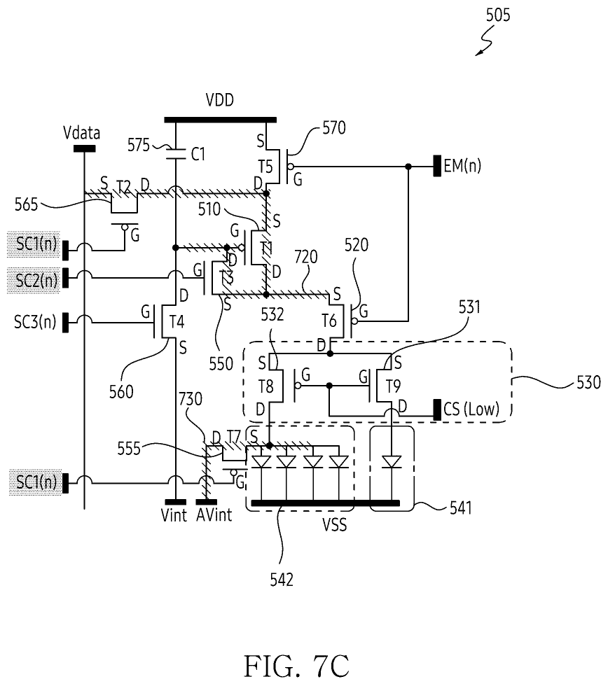

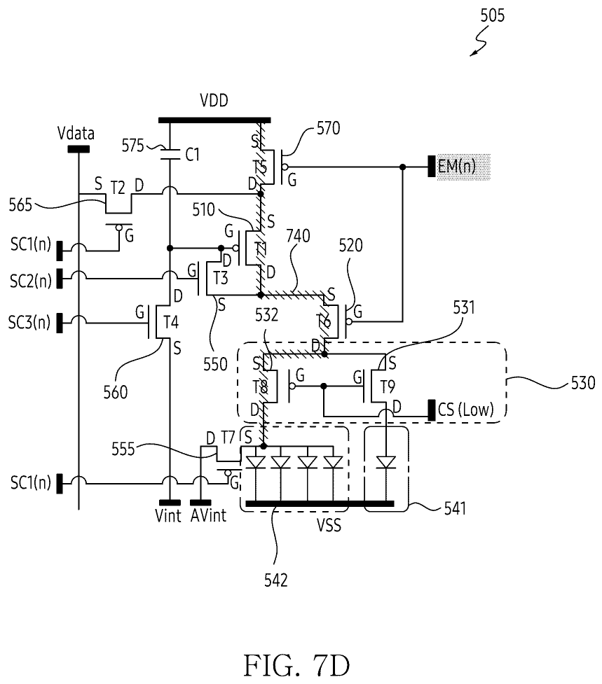

FIGS. 7A to 7D illustrate an example of a method of driving selective compensation circuitry in a second mode.

The selective compensation circuitry may indicate the compensation circuitry 505 of FIG. 5 including a switch 530 for selecting a first light-emitting element 541 for the first mode or second light-emitting elements 542 for the second mode among a plurality of light-emitting elements. For example, the method of FIGS. 7A to 7D may be performed through the compensation circuitry 505 of FIG. 5.

Referring to FIG. 7A, a timing diagram 700 exemplifying the first scan performed in the second mode is illustrated. For example, the first scan may be referred to as an address scan. For example, the address scan may include initializing a gate of a driving transistor 510, applying a data voltage to the initialized gate, and providing a current to a light-emitting element (e.g., the first light-emitting element 541 or the second light-emitting elements 542) through the driving transistor 510 in which the data voltage is applied to the gate.

Referring to the timing diagram 700 of FIG. 7A, for example, an initiating transistor 560 may be driven (or turned on) based on a scan signal SC3 applied in a time interval 701. The scan signal SC3 being applied may indicate a case in which a voltage of the scan signal SC3 is high. However, an embodiment of the present disclosure is not limited thereto. For example, the scan signal SC3 may also be applied in a case that the voltage of the scan signal SC3 is low in accordance with a transistor to which the voltage is applied.

As the initiating transistor 560 is driven, the gate of the driving transistor 510 may be initialized. Referring to FIG. 7B, the initiating transistor 560 may be changed from a turn off state to a turn on state based on the scan signal SC3 applied to a gate G of the initiating transistor 560. Through a path 710 formed accordingly, an initiating voltage Vint may be applied to the gate G of the driving transistor 510. The gate G of the driving transistor 510 may be initialized based on the initiating voltage Vint. In other words, a gate voltage of the driving transistor 510 may be changed to the initiating voltage Vint.

Referring to the timing diagram 700 of FIG. 7A, for example, since the scan signal SC3 is not applied (or when the voltage of the scan signal SC3 is low) after the time interval 701, the driving of the initiating transistor 560 may be ceased.

Referring to the timing diagram 700 of FIG. 7A, for example, a switching transistor 565 may be driven (or turned on) based on a scan signal SC1 applied in a time interval 702. The scan signal SC1 being applied may indicate a case in which a voltage of the scan signal SC1 is low. However, an embodiment of the present disclosure is not limited thereto, and the scan signal SC1 may also be applied in a case that the voltage of the scan signal SC1 is high in accordance with a transistor to which the voltage is applied. In addition, a compensating transistor 550 may be driven (or turned on) based on a scan signal SC2 applied in a time interval 703. The scan signal SC2 being applied may indicate a case in which a voltage of the scan signal SC2 is high. However, an embodiment of the present disclosure is not limited thereto, and the scan signal SC2 may also be applied in a case that the voltage of the scan signal SC2 is low in accordance with a transistor to which the voltage is applied.

As the switching transistor 565 and the compensating transistor 550 are driven, a data voltage may be provided to the driving transistor 510. Referring to FIG. 7C, the switching transistor 565 may be changed from a turn off state to a turn on state based on the scan signal SC1 applied to a gate G of the switching transistor 565. The compensating transistor 550 may be changed from a turn off state to a turn on state based on the scan signal SC2 applied to a gate G of the compensating transistor 550. Through a path 720 formed accordingly, a data voltage Vdata may be applied to the gate G of the driving transistor 510 by passing through the switching transistor 565 and the compensating transistor 550. In other words, the data voltage Vdata may be applied to the initialized gate G of the driving transistor 510.

In addition, referring to the timing diagram 700 of FIG. 7A, for example, a bypassing transistor 555 may be driven (or turned on) based on the scan signal SC1 applied in the time interval 702. The scan signal SC1 being applied may indicate a case in which the voltage of the scan signal SC1 is low. However, an embodiment of the present disclosure is not limited thereto, and the scan signal SC1 may also be applied in a case that the voltage of the scan signal SC1 is high in accordance with the transistor to which the voltage is applied.

As the bypassing transistor 555 is driven, an anode of each of the second light-emitting elements 542 may be initialized. Referring to FIG. 7C, the bypassing transistor 555 may be changed from a turn off state to a turn on state based on the scan signal SC1 applied to a gate G of the bypassing transistor 555. Through a path 730 formed accordingly, an anode initiating voltage AVint may be applied to the anode of each of the second light-emitting elements 542. The second light-emitting elements 542 may be initialized based on the anode initiating voltage AVint.

Referring to the timing diagram 700 of FIG. 7A, for example, since the scan signal SC1 and the scan signal SC3 are not applied after the time interval 702 and the time interval 703, the driving of the switching transistor 565, the compensating transistor 550, and the bypassing transistor 555 may be ceased.

Referring to the timing diagram 700 of FIG. 7A, for example, a driving control transistor 570 and an emitting control transistor 520 may be driven (or turned on) based on an emission signal EM applied in a time interval 705. The emission signal EM being applied may indicate a case in which a voltage of the emission signal EM is low. However, an embodiment of the present disclosure is not limited thereto, and the emission signal EM may be applied in a case that the voltage of the emission signal EM is high in accordance with a transistor to which the voltage is applied. Unlike the example of FIG. 6A, referring to the timing diagram 700, a control signal CS may be low in an entire time interval in the first mode. For example, a second transistor 532 of a first transistor 531 and the second transistor 532 may be driven based on the control signal CS having a low voltage applied to the first transistor 531 and the second transistor 532.

As the driving control transistor 570, the emitting control transistor 520, and the second transistor 532 of the switch 530 are driven, the second light-emitting elements 542 may emit light. Referring to FIG. 7D, the driving control transistor 570 and the emitting control transistor 520 may be changed from a turn off state to a turn on state based on the emission signal EM applied to a gate G of the driving control transistor 570 and the emitting control transistor 520. The second transistor 532 may be changed from a turn off state to a turn on state based on the control signal CS applied to a gate G of the second transistor 532. Through a path 740 formed accordingly, a current may be applied to the second light-emitting elements 542. The second light-emitting elements 542 among the first light-emitting element 541 and the second light-emitting elements 542 may emit light through the second transistor 532 of the switch 530 identified by the control signal. In other words, the second light-emitting elements 542 selected from among the first light-emitting element 541 and the second light-emitting elements 542 may be driven.

As described above, the first scan executed in the second mode may include initializing a gate, applying a data voltage to the gate, and providing a current to a light-emitting element, as described in FIGS. 7A to 7D.

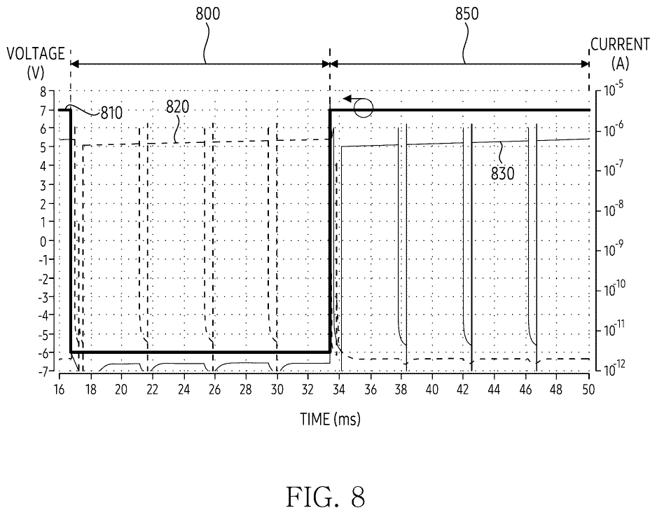

FIG. 8 illustrates an example of a graph indicating a current applied to light-emitting elements in accordance with a mode.

FIG. 8 illustrates an example of graphs 800 and 850 indicating currents applied to light-emitting elements in accordance with the first mode or the second mode. For example, in the graphs 800 and 850, a horizontal axis may indicate time (unit: ms), a left vertical axis may indicate a voltage (unit: V), and a right vertical axis may indicate a current (unit: A). For example, the left vertical axis may indicate a value of a voltage of a control signal in the graphs 800 and 850. For example, the right vertical axis may indicate a value of a current of a light-emitting element in the graphs 800 and 850.

In FIG. 8, an example of changing from the second mode to the first mode over time is illustrated. For example, the graphs 800 and 850 illustrate a first line 810 indicating the voltage of the control signal, a second line 820 indicating a current applied to the second light-emitting elements 542 of FIG. 5, and a third line 830 indicating a current applied to the first light-emitting element 541 of FIG. 5.

Referring to the graph 800, the first line 810 may indicate the control signal having a low voltage. For example, a value of the first line 810 may be approximately −6 V. In contrast, referring to the graph 850, the first line 810 may indicate the control signal having a high voltage. For example, the value of the first line 810 may be approximately +7 V. A state in which the voltage of the control signal is low may indicate a state in which a display panel (e.g., a display panel 210) (or a sub-pixel in the display panel) is driven in the second mode. In contrast, a state in which the voltage of the control signal is high may indicate a state in which the display panel is driven in the first mode.

For example, the graph 800 may indicate an example in which an emission signal is provided four times during one frame. For example, emission signals may be provided in approximately 18 ms to approximately 21 ms, approximately 22 ms to approximately 25 ms, approximately 26 ms to approximately 29 ms, and approximately 30 ms to approximately 33 ms. While the emission signal is provided, a value of the second line 820 may be approximately 10⁻⁶ A. In a time period in which the emission signal is not provided, the value of the second line 820 may be approximately 10⁻¹² A. In contrast, regardless of the provision of the emission signal, a value of the third line 830 may be approximately 10⁻¹² A. Referring to the above description, in the second mode in accordance with driving of a switch (e.g., the switch 530 of FIG. 5), a current may be provided to the second light-emitting elements 542 and a current may not be provided to the first light-emitting element 541. For example, as a second transistor 532 of the switch 530 is driven, the current may be provided to the second light-emitting elements 542.

For example, the graph 850 may indicate an example in which an emission signal is provided four times during one frame. For example, emission signals may be provided in approximately 35 ms to approximately 38 ms, approximately 39 ms to approximately 42 ms, approximately 43 ms to approximately 46 ms, and approximately 47 ms to approximately 50 ms. While the emission signal is provided, a value of the third line 830 may be approximately 10⁻⁶ A. In a time period in which the emission signal is not provided, the value of the third line 830 may be approximately 10⁻¹² A. In contrast, regardless of the provision of the emission signal, the value of the second line 820 may be approximately 10⁻¹² A. Referring to the above description, in the first mode in accordance with the driving of the switch (e.g., the switch 530 of FIG. 5), a current may be provided to the first light-emitting element 541 and a current may not be provided to the second light-emitting elements 542. For example, as a first transistor 531 of the switch 530 is driven, the current may be provided to the first light-emitting element 541.

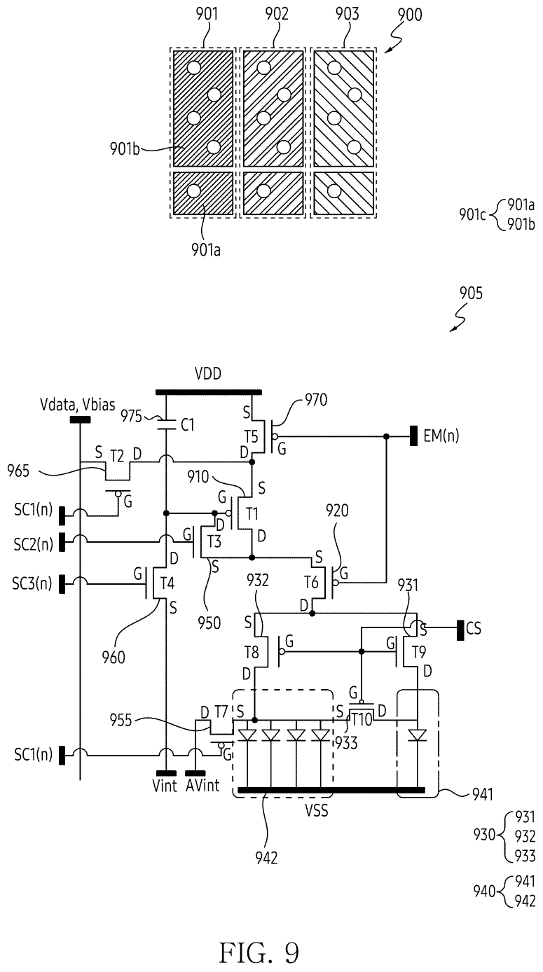

Referring to FIGS. 5 to 8, an electronic device and a method according to an embodiment of the present disclosure may include a switch for selecting a light-emitting element for light emission. The electronic device and the method according to an embodiment of the present disclosure may selectively drive a light-emitting element for light emission based on the switch. By selectively using the light-emitting element based on the switch, the electronic device and the method according to an embodiment of the present disclosure may improve yield and provide maximum luminance through the second mode and reduce power consumption through the first mode. Hereinafter, in FIG. 9, a structure of driving the first mode using one light-emitting element among all of light-emitting elements included in one sub-pixel (or compensation circuitry) and driving the second mode using all of the light-emitting elements, by using an additional transistor in a switch structure of FIG. 5 is described.

FIG. 9 illustrates an example of compensation circuitry for selective driving of a light-emitting element.

Referring to FIG. 9, one pixel 900 may include a plurality of sub-pixels 901, 902, and 903. For example, each of the plurality of sub-pixels 901, 902, and 903 may include a plurality of light-emitting elements. For example, the first sub-pixel 901 may include five light-emitting elements. For example, the second sub-pixel 902 may include five light-emitting elements. For example, the third sub-pixel 903 may include five light-emitting elements. Light-emitting elements illustrated in the pixel 900 of FIG. 9 may indicate light-emitting elements capable of emitting light. For example, the plurality of light-emitting elements may include a micro LED. However, an embodiment of the present disclosure is not limited thereto, and another type of light-emitting elements may also be applied to an electronic device and a method according to an embodiment of the present disclosure.

Referring to FIG. 9, light-emitting elements 901c included in the first sub-pixel 901 in the pixel 900 may include a first light-emitting element 901a for the first mode for low power and the second mode different from the first mode, and second light-emitting elements 901b for the second mode. In other words, compensation circuitry 905 of FIG. 9 may use the first light-emitting element 901a in the first mode, and the light-emitting elements 901c including the first light-emitting element 901a and the second light-emitting elements 901b in the second mode.

Referring to FIG. 9, an example of the compensation circuitry 905 for the first sub-pixel 901 is illustrated. For example, the compensation circuitry 905 may include a plurality of transistors, a capacitor, and a plurality of light-emitting elements. For example, the compensation circuitry 905 may include a switch 930 including seven transistors 910, 920, 950, 955, 960, 965, 970, and 975 and three transistors 931, 932, and 933. For example, the compensation circuitry 905 may include one capacitor 975 (C1), and a plurality of light-emitting elements 940. However, the above-described example is merely exemplary for convenience of description, and an embodiment of the present disclosure is not limited thereto.

For example, the compensation circuitry 905 may be included in a display panel 210. For example, the first sub-pixel 901 including the compensation circuitry 905 may be included in the display panel 210. For example, the compensation circuitry 905 may be controlled by the DDI 230 of FIG. 2. For example, scan signals SC1, SC2, and SC3 and a control signal CS applied to the compensation circuitry 905 may be provided from the DDI 230 to the compensation circuitry 905.

For example, the compensation circuitry 905 may include a driving transistor 910 (T1), a switching transistor 965 (T2), a compensating transistor 950 (T3), an initiating transistor 960 (T4), a driving control transistor 970 (T5), an emitting control transistor 920 (T6), and a bypassing transistor 955 (T7).

For example, the driving transistor 910 may be a transistor for providing a current to the light-emitting elements 940. For example, the driving transistor 910 may provide a current to the light-emitting elements 940 through a path formed by driving the operation control transistor 970, the emitting control transistor 920, and the switch 930. For example, the current may be identified based on a data voltage (or a bias voltage) provided by switching of the switching transistor 965. For example, the driving transistor 910 may include a source S connected to a drain D of the operation control transistor 970 and a drain D of the switching transistor 965. For example, the driving transistor 910 may include a drain D connected to a source S of the compensating transistor 950 and a source S of the emitting control transistor 920. For example, the driving transistor 910 may include a gate G connected to a capacitor 915, a drain D of the compensating transistor 950, and a drain D of the initiating transistor 960. Each of the source S, the drain D, and the gate G may indicate a terminal (or an electrode) of a transistor. For example, the driving transistor 910 may include a P-type metal oxide semiconductor (PMOS) thin film transistor (TFT).

For example, the switching transistor 965 may be a transistor for providing a data voltage Vdata or a bias voltage Vbias. For example, the switching transistor 965 may be driven based on the scan signal SC1. For example, the data voltage Vdata may indicate data processed by DDI (e.g., the DDI 230 of FIG. 2) to display an image obtained from a processor (e.g., the processor 120 of FIG. 1). For example, the bias voltage Vbias may indicate a voltage used when scanning is used in the first mode for low power. For example, the bias voltage Vbias may be a voltage for adjusting a characteristic of the driving transistor 910. The scanning may include the self scanning or the second scan. For example, the switching transistor 965 may include a source S to which the data voltage Vdata and the bias voltage Vbias are applied. For example, the switching transistor 965 may include a drain D connected to the drain D of the operation control transistor 970 and the source S of the driving transistor. For example, the switching transistor 965 may include a gate G, to which the scan signal SC1 is applied, connected to a gate G of the bypassing transistor 955. For example, the switching transistor 965 may include a PMOS TFT.

For example, the compensating transistor 950 may be a transistor for compensating a gate voltage of the driving transistor 910. For example, the data voltage Vdata or the bias voltage Vbias applied through switching of the switching transistor 965 may be transmitted to the compensating transistor 950 through the driving transistor 910. At this time, based on a diode connection, the data voltage Vdata or the bias voltage Vbias may be provided to the compensating transistor 950 by passing through the driving transistor 910, without a gate voltage applied to the gate G of the driving transistor 910. Accordingly, the gate voltage for the gate G of the driving transistor 910 may be changed to a value that is a sum of the data voltage and a threshold voltage of the driving transistor 910. For example, the compensating transistor 950 may include the source S connected to the drain D of the driving transistor 910 and the source S of the emitting control transistor 920. For example, the compensating transistor 950 may include the drain D connected to the gate G of the driving transistor 910, the capacitor 915, and the drain D of the initiating transistor 960. For example, the compensating transistor 950 may include a gate G to which the scan signal SC2 is applied. For example, the compensating transistor 950 may include an N-type metal oxide semiconductor (NMOS) thin film transistor (TFT).

For example, the initiating transistor 960 may be a transistor for performing voltage initialization. For example, in response to the scan signal SC3 applied to a gate G of the initiating transistor 960, an initiating voltage Vint applied to a source S of the initiating transistor 960 may be provided to the driving transistor 910. For example, the initiating transistor 960 may include the source S to which the initiating voltage is applied. For example, the initiating transistor 960 may include the drain D connected to the drain D of the compensating transistor 950, the gate G of the driving transistor 910, and the capacitor 975. For example, the initiating transistor 960 may include the gate G to which the scan signal SC3 is applied. For example, the initiating transistor 960 may include an NMOS TFT.

For example, the driving control transistor 970 may be a transistor for providing a driving voltage VDD. The driving control transistor 970 may be referred to as an emitting control transistor, like the emitting control transistor 920. For example, the driving control transistor 970 may include a source S to which the driving voltage VDD is applied. For example, the driving control transistor 970 may include the drain D connected to the drain D of the switching transistor 965 and the source S of the driving transistor 910. For example, the driving control transistor 970 may include a gate G, to which an emission signal EM is applied, connected to a gate G of the emitting control transistor 920. For example, the driving control transistor 970 may include a PMOS TFT.

For example, the emitting control transistor 920 may be a transistor that controls the light-emitting elements 941 and 942 to emit light based on the emission signal EM. For example, as the emission signal EM is applied, a path may be formed between the switch 930 and a node to which the driving voltage VDD is applied. For example, the emitting control transistor 920 may include the source S connected to the drain D of the driving transistor 910 and the source S of the compensating transistor 950. For example, the emitting control transistor 920 may include a drain D connected to the switch 930. For example, the drain D of the emitting control transistor 920 may be connected to a source S of the first transistor 931 and a source S of the second transistor 932 of the switch 930. For example, the emitting control transistor 920 may include the gate G, to which the emission signal EM is applied, connected to the gate G of the operation control transistor 970. For example, the emitting control transistor 920 may include a PMOS TFT.

For example, the bypassing transistor 955 may be a transistor for bypassing a leakage current among currents provided to the light-emitting elements 940. For example, by using the leakage current among the currents provided to the light-emitting elements 940 by passing through the emitting control transistor 920, contrast at a low current may be improved. For example, the bypassing transistor 955 may include the source S connected to an anode of each of the light-emitting elements 940, a drain D of the second transistor 932, and a source S of the third transistor 933. For example, the bypassing transistor 955 may include a drain D connected to a node to which an anode initiating voltage AVint is applied. For example, the bypassing transistor 955 may include the gate G, to which the scan signal SC1 is applied, connected to the gate G of the switching transistor 965. For example, the bypassing transistor 955 may include a PMOS TFT.

For example, the switch 930 may include three transistors. For example, the switch 930 may include the first transistor 931 (T9) driven (or turned on) in the first mode for low power, and the second transistor 932 (T8) and the third transistor 933 (T10) driven in the second mode different from the first mode.

For example, the first transistor 931 may include the source S connected to the drain D of the emitting control transistor 920 and the source S of the second transistor 932. For example, the first transistor 931 may include a drain D connected to an anode of the first light-emitting element 941 and a drain D of the third transistor 933. For example, the first transistor 931 may include a gate G, to which the control signal CS is applied, connected to a gate G of the second transistor 932 and a gate G of the third transistor 933.

For example, the second transistor 932 may include the source S connected to the drain D of the emitting control transistor 920 and the source S of the first transistor 931. For example, the second transistor 932 may include a drain D connected to an anode of each of the second light-emitting elements 942, the source S of the bypassing transistor 955, and the source S of the third transistor 933. For example, the second transistor 932 may include a gate G, to which the control signal CS is applied, connected to the gate G of the first transistor 931 and the gate G of the third transistor 933.

For example, the third transistor 933 may include the source S connected to the drain D of the second transistor 932, the source S of the bypassing transistor 955, and the anode of each of the second light-emitting elements 942. For example, the third transistor 933 may include the drain D connected to the drain D of the first transistor 931 and the anode of the first light-emitting element 941. For example, the third transistor 933 may include the gate G, to which the control signal CS is applied, connected to the gate G of the first transistor 931 and the gate G of the second transistor 932. The third transistor 933 may be referred to as a selecting transistor.

The control signal CS may be provided from the DDI (e.g., the DDI 230). For example, the control signal CS may be provided to all sub-pixels in the display panel (e.g., the display panel 210). In other words, the control signal CS may be provided to all lines (or all sub-pixels) other than being provided for each line, such as the scan signals SC1, SC2, and SC3. The line may be referred to as a set of a plurality of sub-pixels triggered by a horizontal synchronization signal or a component connected to the plurality of sub-pixels in the set.

For example, the first transistor 931 and the second transistor 932 may be of different types. For example, in a case that the first transistor 931 is an NMOS TFT, the second transistor 932 may be a PMOS TFT. Alternatively, in a case that the first transistor 931 is a PMOS TFT, the second transistor 932 may be an NMOS TFT.

For example, the second transistor 932 and the third transistor 933 may be of the same type. For example, in a case that the second transistor 932 is a PMOS TFT, the second transistor 933 may be a PMOS TFT. Alternatively, in a case that the second transistor 932 is an NMOS TFT, the third transistor 933 may be an NMOS TFT.

In FIG. 9, an example of the switch 930 to which one control signal is applied is illustrated, but an embodiment of the present disclosure is not limited thereto. For example, the gate G of the first transistor 931, the gate G of the second transistor 932, and the gate G of the third transistor 933 are not connected to each other, and different control signals may be applied to each of the gate G of the first transistor 931, the gate G of the second transistor 932, and the gate G of the third transistor 933.

For example, the capacitor 975 may be charged based on the data voltage or initialized based on the initiating voltage Vint. For example, the capacitor 975 may be connected to the driving voltage VDD, the gate G of the driving transistor 910, the drain D of the compensating transistor 950, and the drain D of the initiating transistor 960. For example, the capacitor 975 may be referred to as a storage capacitor.

For example, the light-emitting elements 940 may emit light based on a current controlled by the driving transistor 910. For example, in the first mode, a current may be provided to the first light-emitting element 941 through a path based on the operation control transistor 970 and the emitting control transistor 960 driven by the emission signal EM, the first transistor 931 driven by the control signal CS, and the driving transistor 910. Accordingly, the first light-emitting element 941 may emit light. In addition, for example, in the second mode, a current may be provided to the light-emitting elements 940 through a path based on the operation control transistor 970 and the emitting control transistor 960 driven by the emission signal EM, the second transistor 932 and the third transistor 933 driven by the control signal CS, and the driving transistor 910. Accordingly, both the first light-emitting element 941 and the second light-emitting elements 942 may emit light. For example, the first light-emitting element 941 may include the anode connected to the drain D of the first transistor 931. For example, the first light-emitting element 941 may include a cathode connected to a driving voltage VSS. For example, each of the second light-emitting elements 942 may include the anode connected to the drain D of the second transistor 932. For example, each of the second light-emitting elements 942 may include the cathode connected to the driving voltage VSS.

Although not illustrated in FIG. 9, for example, the compensation circuitry 905 may further include a compensation capacitor for improving a luminance deviation. Specific content related to this is described in FIGS. 13A to 14C below.

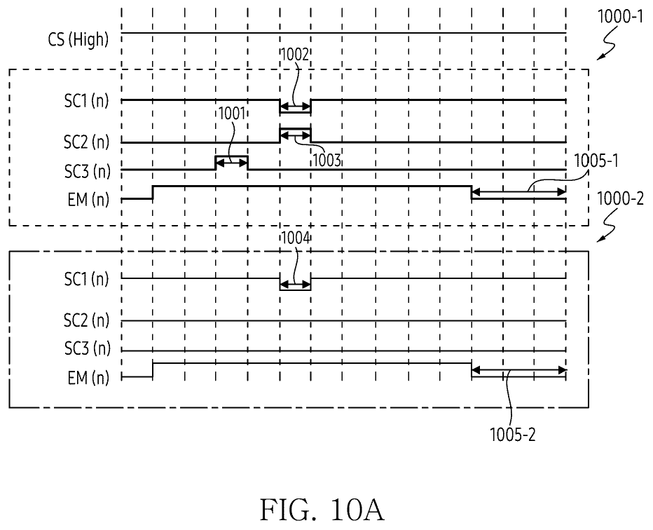

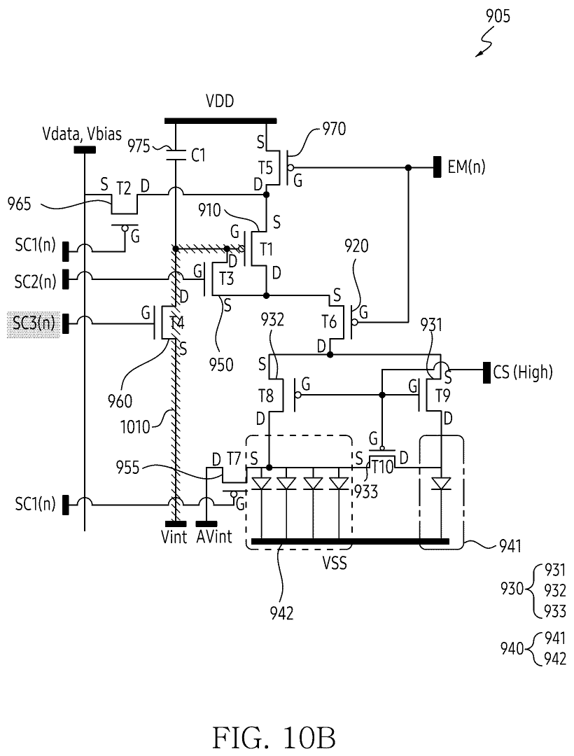

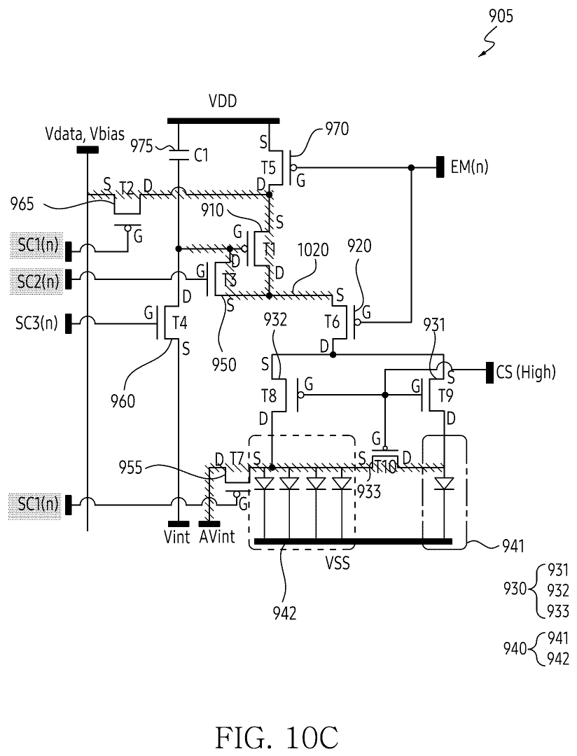

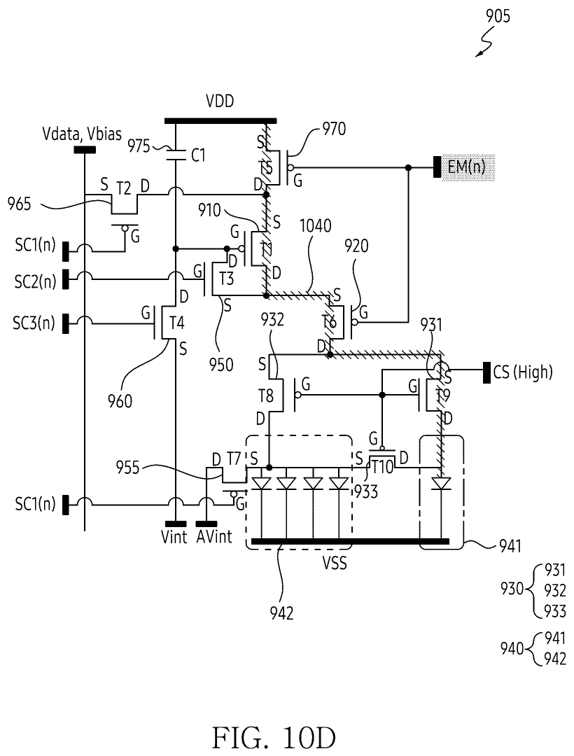

FIGS. 10A to 10D illustrate an example of a method of driving selective compensation circuitry in a first mode.

The selective compensation circuitry may indicate the compensation circuitry 505 of FIG. 9 including a switch 930 for selecting a first light-emitting element 941 for the first mode or light-emitting elements 940 for the second mode among a plurality of light-emitting elements. For example, the method of FIGS. 10A to 10D may be performed through the compensation circuitry 905 of FIG. 9.

Referring to FIG. 10A, a timing diagram 1000-1 exemplifying the first scan performed in the first mode and a timing diagram 1000-2 exemplifying the second scan performed in the first mode are illustrated. For example, the first scan may be referred to as an address scan. For example, the second scan may be referred to as a self scanning. For example, the address scan may include initializing a gate of a driving transistor 910, applying a data voltage to the initialized gate, and providing a current to a light-emitting element (e.g., the first light-emitting element 941 or the light-emitting elements 940) through the driving transistor 910 in which the data voltage is applied to the gate. For example, unlike the address scan, the self scanning may include providing the current to the light-emitting element (e.g., the first light-emitting element 941 or the light-emitting elements 940) through the driving transistor 910 from among initializing the gate, applying the data voltage to the initialized gate, and providing the current to the light-emitting element (e.g., the first light-emitting element 941 or the light-emitting elements 940) through the driving transistor 910.

Referring to the timing diagram 1000-1 of FIG. 10A, for example, an initiating transistor 960 may be driven (or turned on) based on a scan signal SC3 applied in a time interval 1001. The scan signal SC3 being applied may indicate a case in which a voltage of the scan signal SC3 is high. However, an embodiment of the present disclosure is not limited thereto, and the scan signal SC3 may also be applied in a case that the voltage of the scan signal SC3 is low in accordance with a transistor to which the voltage is applied.

As the initiating transistor 960 is driven, the gate of the driving transistor 910 may be initialized. Referring to FIG. 10B, the initiating transistor 960 may be changed from a turn off state to a turn on state based on the scan signal SC3 applied to a gate G of the initiating transistor 960. Through a path 1010 formed accordingly, an initiating voltage Vint may be applied to the gate G of the driving transistor 910. The gate G of the driving transistor 910 may be initialized based on the initiating voltage Vint. In other words, a gate voltage of the driving transistor 910 may be changed to the initiating voltage Vint.

Referring to the timing diagram 1000-1 of FIG. 10A, for example, since the scan signal SC3 is not applied (or when the voltage of the scan signal SC3 is low) after the time interval 1001, the driving of the initiating transistor 960 may be ceased.

Referring to the timing diagram 1000-1 of FIG. 10A, for example, a switching transistor 965 may be driven (or turned on) based on a scan signal SC1 applied in a time interval 1002. The scan signal SC1 being applied may indicate a case in which a voltage of the scan signal SC1 is low. However, an embodiment of the present disclosure is not limited thereto, and the scan signal SC1 may also be applied in a case that the voltage of the scan signal SC1 is high in accordance with a transistor to which the voltage is applied. In addition, a compensating transistor 950 may be driven (or turned on) based on a scan signal SC2 applied in a time interval 1003. The scan signal SC2 being applied may indicate a case in which a voltage of the scan signal SC2 is high. However, an embodiment of the present disclosure is not limited thereto, and the scan signal SC2 may also be applied in a case that the voltage of the scan signal SC2 is low in accordance with a transistor to which the voltage is applied.

As the switching transistor 965 and the compensating transistor 950 are driven, a data voltage may be provided to the driving transistor 910. Referring to FIG. 10C, the switching transistor 965 may be changed from a turn off state to a turn on state based on the scan signal SC1 applied to a gate G of the switching transistor 965. The compensating transistor 950 may be changed from a turn off state to a turn on state based on the scan signal SC2 applied to a gate G of the compensating transistor 950. Through a path 1020 formed accordingly, a data voltage Vdata may be applied to the gate G of the driving transistor 910 by passing through the switching transistor 965 and the compensating transistor 950. In other words, the data voltage Vdata may be applied to the initialized gate G of the driving transistor 910.

Referring to the timing diagram 1000-1 of FIG. 10A, for example, since the scan signal SC1 and the scan signal SC3 are not applied after the time interval 1002 and the time interval 1003, the driving of the switching transistor 965 and the compensating transistor 950 may be ceased.

Referring to the timing diagram 1000-1 of FIG. 10A, for example, a driving control transistor 970 and an emitting control transistor 920 may be driven (or turned on) based on an emission signal EM applied in a time interval 1005-1. The emission signal EM being applied may indicate a case in which a voltage of the emission signal EM is low. However, an embodiment of the present disclosure is not limited thereto, and the emission signal EM may also be applied in a case that the voltage of the emission signal EM is high in accordance with a transistor to which the voltage is applied. In addition, referring to the timing diagram 1000-1, a control signal CS may be high in an entire time interval in the first mode. For example, a first transistor 931 among the first transistor 931, a second transistor 932, and a third transistor 933 may be driven based on the control signal CS having a high voltage applied to the first transistor 931, the second transistor 932, and the third transistor 933.

As the driving control transistor 970, the emitting control transistor 920, and the first transistor 931 of the switch 930 are driven, the first light-emitting element 941 may emit light. Referring to FIG. 10D, the driving control transistor 970 and the emitting control transistor 920 may be changed from a turn off state to a turn on state based on the emission signal EM applied to a gate G of the driving control transistor 970 and the emitting control transistor 920. The first transistor 931 may be changed from a turn off state to a turn on state based on the control signal CS applied to a gate G of the first transistor 931. Through a path 1040 formed accordingly, a current may be applied to the first light-emitting element 941. The first light-emitting element 941, which is a partial light-emitting element among the light-emitting elements 940, may emit light through the first transistor 931 of the switch 930 identified by the control signal. In other words, the first light-emitting element 941 selected from among the light-emitting elements 940 may be driven.

As described above, the first scan executed in the first mode may include initializing a gate G, applying a data voltage to the gate G, and providing a current to a light-emitting element, as described in FIGS. 10A to 10D. In contrast, the second scan executed in the first mode may be referenced to the timing diagram 1000-2.

Referring to the timing diagram 1000-2 of FIG. 10A, for example, the switching transistor 965 may be driven (or turned on) based on the scan signal SC1 applied in a time interval 1004. The scan signal SC1 being applied may indicate a case in which the voltage of the scan signal SC1 is low. However, an embodiment of the present disclosure is not limited thereto, and the scan signal SC1 may also be applied in a case that the voltage of the scan signal SC1 is high in accordance with the transistor to which the voltage is applied.

As the switching transistor 965 is driven, a bias voltage may be provided to the driving transistor 910. Referring to FIG. 10C, the switching transistor 965 may be changed from the turn off state to the turn on state based on the scan signal SC1 applied to the gate G of the switching transistor 965. Through a portion of the path 1020 formed accordingly, the bias voltage Vbias may be applied to a source S of the driving transistor 910 and a drain D of the driving transistor 910.

Referring to the timing diagram 1000-2 of FIG. 10A, for example, since the scan signal SC1 is not applied after the time interval 1004, the driving of the switching transistor 965 may be ceased.

Referring to the timing diagram 1000-2 of FIG. 10A, for example, the driving control transistor 970 and the emitting control transistor 920 may be driven (or turned on) based on the emission signal EM applied in a time interval 1005-2. The emission signal EM being applied may indicate a case in which the voltage of the emission signal EM is low. However, an embodiment of the present disclosure is not limited thereto, and the emission signal EM may also be applied in a case that the voltage of the emission signal EM is high in accordance with the transistor to which the voltage is applied. In addition, referring to the timing diagram 1000-2, the control signal CS may be high in the entire time interval in the first mode. For example, the first transistor 931 among the first transistor 931, the second transistor 932, and the third transistor 933 may be driven based on the control signal CS having the high voltage applied to the first transistor 931, the second transistor 932, and the third transistor 933.

As the driving control transistor 970, the emitting control transistor 920, and the first transistor 931 of the switch 930 are driven, the first light-emitting element 941 may emit light. Referring to FIG. 10D, the driving control transistor 970 and the emitting control transistor 920 may be changed from the turn off state to the turn on state based on the emission signal EM applied to the gate G of the driving control transistor 970 and the emitting control transistor 920. The first transistor 931 may be changed from the turn off state to the turn on state based on the control signal CS applied to the gate G of the first transistor 931. Through the path 1040 formed accordingly, the current may be applied to the first light-emitting element 941. The first light-emitting element 941, which is a partial light-emitting element among the light-emitting elements 940, may emit light through the first transistor 931 of the switch 930 identified by the control signal. In other words, the first light-emitting element 941 selected from among the light-emitting elements 940 may be driven.

As described above, the second scan executed in the first mode may include providing a current to a light-emitting element based on the bias voltage provided to the driving transistor 910, as described in FIGS. 10C and 10D.

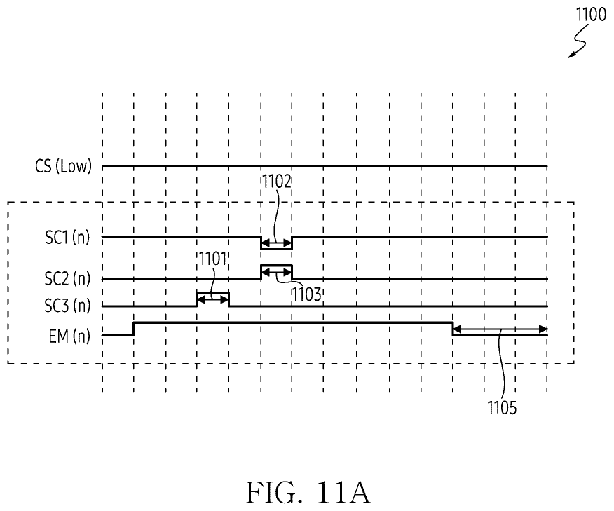

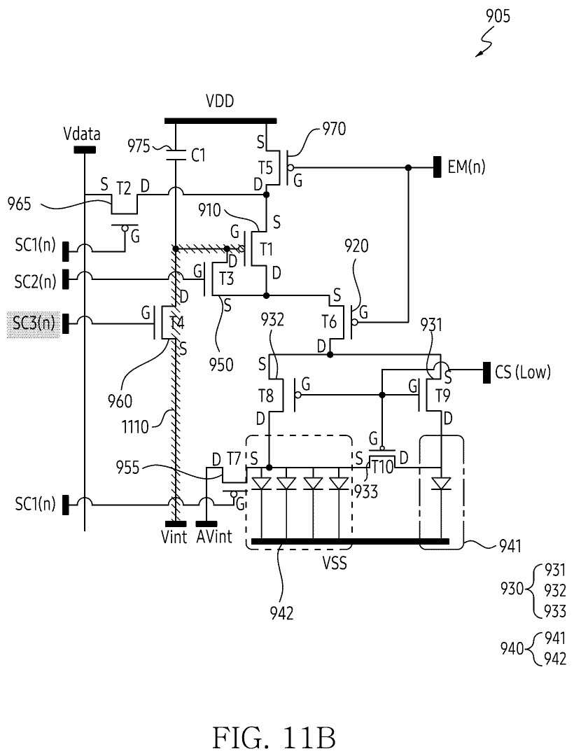

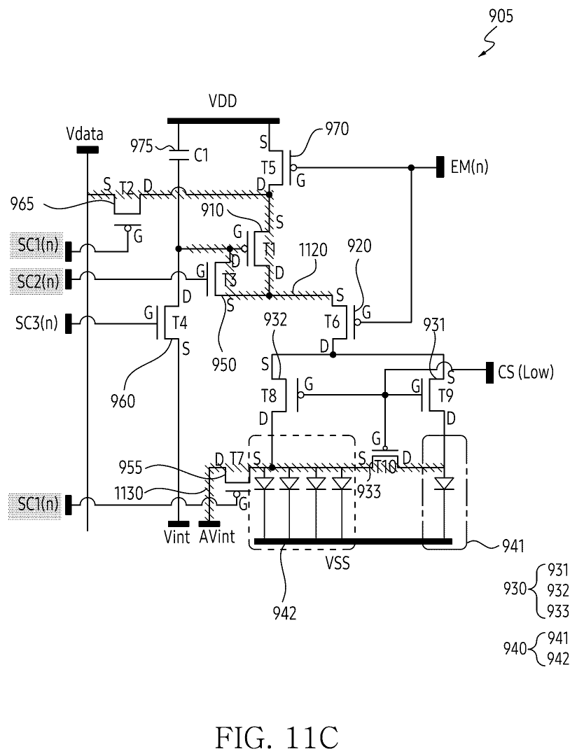

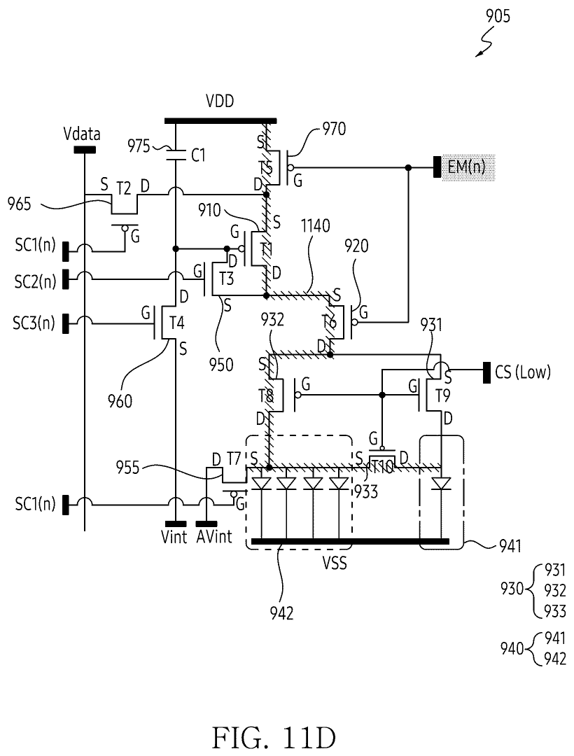

FIGS. 11A to 11D illustrate an example of a method of driving selective compensation circuitry in a second mode.

The selective compensation circuitry may indicate the compensation circuitry 905 of FIG. 9 including a switch 930 for selecting a first light-emitting element 941 for the first mode or light-emitting elements 940 for the second mode among a plurality of light-emitting elements. For example, the method of FIGS. 11A to 11D may be performed through the compensation circuitry 905 of FIG. 9.

Referring to FIG. 11A, a timing diagram 1100 exemplifying the first scan performed in the second mode is illustrated. For example, the first scan may be referred to as an address scan. For example, the address scan may include initializing a gate G of a driving transistor 910, applying a data voltage to the initialized gate G, and providing a current to a light-emitting element (e.g., the first light-emitting element 941 or the light-emitting elements 940) through the driving transistor 910 in which the data voltage is applied to the gate G.

Referring to the timing diagram 1100 of FIG. 11A, for example, an initiating transistor 960 may be driven (or turned on) based on a scan signal SC3 applied in a time interval 1101. The scan signal SC3 being applied may indicate a case in which a voltage of the scan signal SC3 is high. However, an embodiment of the present disclosure is not limited thereto, and the scan signal SC3 may also be applied in a case that the voltage of the scan signal SC3 is low in accordance with a transistor to which the voltage is applied.

As the initiating transistor 960 is driven, the gate of the driving transistor 910 may be initialized. Referring to FIG. 11B, the initiating transistor 960 may be changed from a turn off state to a turn on state based on the scan signal SC3 applied to a gate G of the initiating transistor 960. Through a path 1110 formed accordingly, an initiating voltage Vint may be applied to the gate G of the driving transistor 910. The gate G of the driving transistor 910 may be initialized based on the initiating voltage Vint. In other words, a gate voltage of the driving transistor 910 may be changed to the initiating voltage Vint.

Referring to the timing diagram 1100 of FIG. 11A, for example, since the scan signal SC3 is not applied (or when the voltage of the scan signal SC3 is low) after the time interval 1101, the driving of the initiating transistor 960 may be ceased.

Referring to the timing diagram 1100 of FIG. 11A, for example, a switching transistor 965 may be driven (or turned on) based on a scan signal SC1 applied in a time interval 1102. The scan signal SC1 being applied may indicate a case in which a voltage of the scan signal SC1 is low. However, an embodiment of the present disclosure is not limited thereto, and the scan signal SC1 may also be applied in a case that the voltage of the scan signal SC1 is high in accordance with a transistor to which the voltage is applied. In addition, a compensating transistor 950 may be driven (or turned on) based on a scan signal SC2 applied in a time interval 1103. The scan signal SC2 being applied may indicate a case in which a voltage of the scan signal SC2 is high. However, an embodiment of the present disclosure is not limited thereto, and the scan signal SC2 may also be applied in a case that the voltage of the scan signal SC2 is low in accordance with a transistor to which the voltage is applied.

As the switching transistor 965 and the compensating transistor 950 are driven, a data voltage may be provided to the driving transistor 910. Referring to FIG. 11C, the switching transistor 965 may be changed from a turn off state to a turn on state based on the scan signal SC1 applied to a gate G of the switching transistor 965. The compensating transistor 950 may be changed from a turn off state to a turn on state based on the scan signal SC2 applied to a gate G of the compensating transistor 950. Through a path 1120 formed accordingly, a data voltage Vdata may be applied to the gate G of the driving transistor 910 by passing through the switching transistor 965 and the compensating transistor 950. In other words, the data voltage Vdata may be applied to the initialized gate G of the driving transistor 910.

In addition, referring to the timing diagram 1100 of FIG. 11A, for example, a bypassing transistor 955 may be driven (or turned on) based on the scan signal SC1 applied in the time interval 1102. The scan signal SC1 being applied may indicate a case in which the voltage of the scan signal SC1 is low. However, an embodiment of the present disclosure is not limited thereto, and the scan signal SC1 may also be applied in a case that the voltage of the scan signal SC1 is high in accordance with the transistor to which the voltage is applied.

As the bypassing transistor 955 is driven, an anode of each of the light-emitting elements 940 (e.g., the first light-emitting element 941 and second light-emitting elements 942) may be initialized. Referring to FIG. 11C, the bypassing transistor 955 may be changed from a turn off state to a turn on state based on the scan signal SC1 applied to a gate G of the bypassing transistor 955. Through a path 1130 formed accordingly, an anode initiating voltage AVint may be applied to the anode of each of the light-emitting elements 940. The light-emitting elements 940 may be initialized based on the anode initiating voltage AVint.

Referring to the timing diagram 1100 of FIG. 11A, for example, since the scan signal SC1 and the scan signal SC3 are not applied after the time interval 1102 and the time interval 1103, the driving of the switching transistor 965, the compensating transistor 950, and the bypassing transistor 955 may be ceased.

Referring to the timing diagram 1100 of FIG. 11A, for example, a driving control transistor 970 and an emitting control transistor 920 may be driven (or turned on) based on an emission signal EM applied in a time interval 1105. The emission signal EM being applied may indicate a case in which a voltage of the emission signal EM is low. However, an embodiment of the present disclosure is not limited thereto, and the emission signal EM may also be applied in a case that the voltage of the emission signal EM is high in accordance with a transistor to which the voltage is applied. Unlike the example of FIG. 10A, referring to the timing diagram 1100, a control signal CS may be low in an entire time interval in the first mode. For example, a second transistor 932 and a third transistor 933 among a first transistor 931, the second transistor 932, and the third transistor 933 may be driven based on the control signal CS having a low voltage applied to the first transistor 931, the second transistor 932, and the third transistor 933.

As the driving control transistor 970, the emitting control transistor 920, and the second transistor 932 and the third transistor 933 of the switch 930 are driven, the light-emitting elements 940 may emit light. In other words, both the first light-emitting element 941 and the second light-emitting elements 942 of the light-emitting elements 940 may emit light. Referring to FIG. 11D, the driving control transistor 970 and the emitting control transistor 920 may be changed from a turn off state to a turn on state based on the emission signal EM applied to a gate G of the driving control transistor 970 and the emitting control transistor 920. The second transistor 932 and the third transistor 933 may be changed from a turn off state to a turn on state based on the control signal CS applied to a gate G of the second transistor 932 and a gate G of the third transistor 933. Through a path 1140 formed accordingly, a current may be applied to the light-emitting elements 940. The light-emitting elements 940 including the first light-emitting element 941 and the second light-emitting elements 942 may emit light through the second transistor 932 and the third transistor 933 of the switch 930 identified by the control signal. In other words, both the first light-emitting element 941 and the second light-emitting elements 942 may be driven.

As described above, the first scan executed in the second mode may include initializing a gate, applying a data voltage to the gate, and providing a current to a light-emitting element, as described in FIGS. 11A to 11D.

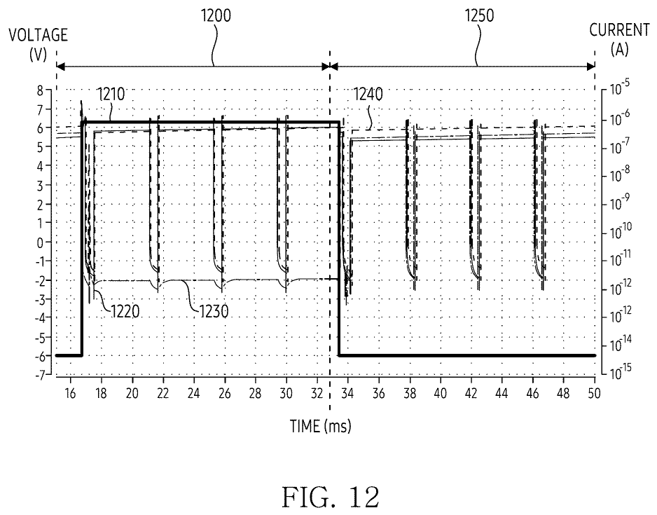

FIG. 12 illustrates an example of a graph indicating a current applied to light-emitting elements in accordance with a mode.

FIG. 12 illustrates an example of graphs 1200 and 1250 indicating currents applied to light-emitting elements in accordance with the first mode or the second mode. For example, in the graphs 1200 and 1250, a horizontal axis may indicate time (unit: ms), a left vertical axis may indicate a voltage (unit: V), and a right vertical axis may indicate a current (unit: A). For example, the left vertical axis may indicate a value of a voltage of a control signal in the graphs 1200 and 1250. For example, the right vertical axis may indicate a value of a current of a light-emitting element in the graphs 1200 and 1250.

In FIG. 12, an example of changing from the first mode to the second mode over time is illustrated. For example, the graphs 1200 and 1250 illustrate a first line 1210 indicating the voltage of the control signal, a second line 1220 indicating a current applied to the first light-emitting element 941 of FIG. 9, a third line 1230 indicating a current applied to the second light-emitting elements 942 of FIG. 9, and a fourth line 1240 indicating a current applied to the light-emitting elements 940 of FIG. 9.

Referring to the graph 1200, the first line 1210 may indicate the control signal having a high voltage. For example, a value of the first line 1210 may be approximately +6 V. Referring to the graph 1250, the first line 1210 may indicate the control signal having a low voltage. For example, the value of the first line 1210 may be approximately −6 V. A state in which the voltage of the control signal is high may indicate a state in which a display panel (e.g., a display panel 210) (or a sub-pixel in the display panel) is driven in the first mode. In contrast, a state in which the voltage of the control signal is low may indicate a state in which the display panel is driven in the second mode.

For example, the graph 1200 may indicate an example in which an emission signal is provided four times during one frame. For example, emission signals may be provided in approximately 18 ms to approximately 21 ms, approximately 22 ms to approximately 25 ms, approximately 26 ms to approximately 29 ms, and approximately 30 ms to approximately 33 ms. While the emission signal is provided, a value of the second line 1220 may be approximately 10⁻⁶ A. In a time period in which the emission signal is not provided, the value of the second line 1220 may be approximately 10⁻¹² A. In contrast, regardless of the provision of the emission signal, a value of the third line 1230 may be approximately 10⁻¹² A. While the emission signal is provided, a value of the fourth line 1240 indicating the current provided to the light-emitting element 940 including the first light-emitting element 941 and the second light-emitting elements 942 may be approximately 10⁻⁶ A. In the time period in which the emission signal is not provided, the value of the fourth line 1240 may be approximately 10⁻¹² A. Referring to the above description, in the first mode in accordance with driving of a switch (e.g., the switch 930 of FIG. 9), a current may be provided to the first light-emitting element 941 and a current may not be provided to the second light-emitting elements 942. For example, as a first transistor 931 of the switch 930 is driven, the current may be provided to the first light-emitting element 941.

For example, the graph 1250 may indicate an example in which an emission signal is provided four times during one frame. For example, emission signals may be provided in approximately 35 ms to approximately 312 ms, approximately 39 ms to approximately 42 ms, approximately 43 ms to approximately 46 ms, and approximately 47 ms to approximately 50 ms. While the emission signal is provided, a value of the third line 1230 may be approximately 10⁻⁶ A. In a time period in which the emission signal is not provided, the value of the third line 1230 may be approximately 10⁻¹² A. While the emission signal is provided, a value of the second line 1220 and the fourth line 1240 may be approximately 10⁻⁶ A. In the time period in which the emission signal is not provided, the value of the second line 1220 and the fourth line 1240 may be approximately 10⁻¹² A. Referring to the above description, in the second mode in accordance with the driving of the switch (e.g., the switch 930 of FIG. 9), a current may be provided to the first light-emitting element 941 and the second light-emitting elements 942. For example, as a second transistor 932 and a third transistor 933 of the switch 930 are driven, a current may be provided to the light-emitting elements 940.

Referring to FIGS. 9 to 12, an electronic device and a method according to an embodiment of the present disclosure may include a switch for selecting a light-emitting element for light emission. The electronic device and the method according to an embodiment of the present disclosure may selectively drive a light-emitting element for light emission based on the switch. For example, the electronic device and the method according to an embodiment of the present disclosure may use all light-emitting elements or some light-emitting elements in a sub-pixel based on the switch. Accordingly, by selectively using the light-emitting element based on the switch, the electronic device and the method according to an embodiment of the present disclosure may improve yield and provide maximum luminance through the second mode and reduce power consumption through the first mode.

FIG. 13A illustrates an example of a graph indicating luminance compensated based on a compensation capacitor.

The compensation capacitor may indicate a capacitor for improving a luminance deviation between a plurality of light-emitting elements in a sub-pixel. Referring to FIG. 13A, a graph 1300 indicating luminance of a light-emitting element in accordance with the number of light-emitting elements is illustrated. In the graph 1300, a horizontal axis may indicate the number of light-emitting elements, and a vertical axis may indicate luminance (unit: nit).

The graph 1300 illustrates a first line 1301 indicating luminance of a sub-pixel (or compensation circuitry) that does not include the compensation capacitor, a second line 1302 indicating luminance of a sub-pixel including a compensation capacitor having a first capacitance, a third line 1303 indicating luminance of a sub-pixel including a compensation capacitor having a second capacitance, and a fourth line 1304 indicating luminance of a sub-pixel including a compensation capacitor having a third capacitance. The first capacitance may be smaller than the second capacitance. The second capacitance may be smaller than the third capacitance.

Referring to the first line 1301 to the fourth line 1304, when the number of light-emitting elements is 5, luminance may all be the same. For example, the luminance may be 126 nits. Referring to the first line 1301 to the fourth line 1304, luminance may decrease as the number of light-emitting elements increases, and luminance may increase as the number of light-emitting elements decreases. At this time, as a capacitance of a compensation capacitor increases, a luminance deviation in accordance with the number of light-emitting elements may decrease. For example, when the number of light-emitting elements is 7, luminance may increase as a capacitance of a compensation capacitor increases. When the number of light-emitting elements is 3, luminance may decrease as a capacitance of a compensation capacitor increases. Referring to the above description, when compared to the sub-pixel (or the compensation circuitry) that does not include the compensation capacitor, a luminance deviation of the sub-pixel including the compensation capacitor having the third capacitance may be reduced. For example, the luminance deviation of the sub-pixel including the compensation capacitor having the third capacitance may be approximately 14% smaller when compared to a luminance deviation of the sub-pixel that does not include the compensation capacitor. Specific content related to improvement of a luminance deviation based on a compensation capacitor is described in FIGS. 13B and 13C below.

FIG. 13B illustrates an example of a graph indicating an anode voltage of a light-emitting element in accordance with the number of light-emitting elements. FIG. 13C illustrates an example of a timing diagram indicating a luminance deviation generated in accordance with the number of light-emitting elements.

FIG. 13B illustrates an example 1310 of compensation circuitry including light-emitting elements 1315 and a compensation capacitor 1317 (CB) and an example 1320 of a graph indicating an anode voltage of a light-emitting element in accordance with the number of light-emitting elements in the compensation circuitry of the example 1310. Referring to the example 1310, the compensation circuitry may include a driving transistor 1313, the plurality of light-emitting elements 1315, and the compensation capacitor 1317. For example, the light-emitting elements 1315 may include five light-emitting elements. For example, the compensation capacitor 1317 may be connected to a drain D of the driving transistor 1313 and a gate G of the driving transistor. The drain D of the driving transistor 1313 may indicate a node connected to an anode of each of the light-emitting elements 1315.

Referring to the example 1320, a line 1325 indicating an anode voltage of the light-emitting elements 1315 in accordance with the number of light-emitting elements 1315 is illustrated. In the example 1320, a horizontal axis may indicate the number of light-emitting elements, and a vertical axis may indicate an anode voltage (unit: mW). Referring to the line 1325, as the number of light-emitting elements increases, overall resistance of light-emitting elements may increase, and the anode voltage of the light-emitting elements 1315 may increase. In addition, as the number of light-emitting elements decreases, overall resistance of all light-emitting elements may decrease, and the anode voltage of the light-emitting elements 1315 may decrease. Referring to the above description, in accordance with the number of light-emitting elements, a node voltage between the drain D of the driving transistor 1313 and the anode of the light-emitting elements 1315 may be changed in accordance with the number of light-emitting elements.

Referring to FIG. 13C, an example 1330 of a timing diagram indicating that a gate voltage of the driving transistor 1313 is changed as an emission signal is applied in a first scan executed in a compensation circuitry is illustrated. Referring to the example 1330, while the first scan is being executed in the compensation circuitry (e.g., the compensation circuitry 300 of FIG. 3A, the compensation circuitry 505 of FIG. 5, or the compensation circuitry 905 of FIG. 9), a voltage of nodes related to the driving transistor 1313 may be changed. For example, in a case that a light-emitting element is applied, a voltage of a node 2 indicating the gate voltage of the driving transistor 1313 may be changed. In an example 1335, as a voltage of an emission signal 1340 is changed from high to low, the emission signal 1340 may be applied. At this time, a gate voltage 1350 of the driving transistor 1313 may be decreased. The gate voltage 1350 being decreased in response to the application of the emission signal 1340 may be an effect of an internal capacitance of the light-emitting elements 1315. In other words, as the number of light-emitting elements 1315 is changed, the gate voltage 1350 may be changed.

Referring to FIGS. 13B and 13C, as the number of light-emitting elements 1315 is changed, an anode voltage, which is a node voltage of the drain D of the driving transistor 1313, may be changed, and the gate voltage of the driving transistor 1313 may also be changed. In a case that the anode voltage and the gate voltage are changed as described above, a value of a current applied to the light-emitting elements 1315 may be changed. Accordingly, a luminance deviation may occur between sub-pixels included in a display panel (e.g., the display panel 210 of FIG. 2).

As described above, in order to minimize or reduce an effect in accordance with the number of light-emitting elements 1315, the compensation capacitor 1317 may be connected to the drain D of the driving transistor 1313 and the gate G of the driving transistor 1313. As the compensation capacitor 1317 is added, a luminance deviation may be reduced by adjusting a capacitance of the compensation capacitor 1317, as described in FIG. 13A. Hereinafter, examples of the compensation circuitry including the compensation capacitor 1317 are illustrated in FIGS. 14A to 14C.

FIGS. 14A to 14C illustrate examples of compensation circuitry including a compensation capacitor.

FIGS. 14A to 14C illustrate an example of compensation circuitry 1401, 1402, and 1403 including a compensation capacitor 1485. For example, each of the compensation circuitry 1401, 1402, and 1403 may include the compensation circuitry 505 of FIG. 5 or the compensation circuitry 905 of FIG. 9. Each of the compensation circuitry 1401, 1402, and 1403 is exemplary for convenience of description, and an embodiment of the present disclosure is not limited to a structure illustrated in FIGS. 14A to 14C.

Referring to FIGS. 14A to 14C, each of the compensation circuitry 1401, 1402, and 1403 may include a plurality of transistors 1410, 1420, 1450, 1455, 1460, 1465, and 1470, a capacitor 1475, a switch 1430, and light-emitting elements 1440.

For example, the plurality of transistors 1410, 1420, 1450, 1455, 1460, 1465, and 1470 may include the driving transistor 1410 (T1), the switching transistor 1465 (T2), the compensating transistor 1450 (T3), the initiating transistor 1460 (T4), the driving control transistor 1470 (T5), the emitting control transistor 1420 (T6), and the bypassing transistor 1455 (T7). For example, the capacitors 1475 (C1) may be referred to as a storage capacitor. For example, the switch 1430 may include a plurality of transistors. For example, the switch 1430 may include the switch 530 of FIG. 5 or the switch 930 of FIG. 9. For example, the light-emitting elements 1440 may include some light-emitting elements used in a first mode for low power and a rest or all of light-emitting elements used in a second mode different from the first mode. The above-described content may be understood to be substantially the same as the content of FIG. 3A, 5A, or 9. Therefore, detailed content is omitted below.

Referring to FIG. 14A, the compensation circuitry 1401 may include an additional transistor 1480 and the compensation capacitor 1485. For example, the additional transistor 1480 may include a source S connected to a gate G of the driving transistor 1410. For example, the additional transistor 1480 may include a drain D connected to the compensation capacitor 1485. For example, the additional transistor 1480 may include a gate G to which an emission signal EM is applied. For example, the compensation capacitor 1485 (C2) may be connected to the drain D of the additional transistor 1480, a source S of the bypassing transistor 1455, a drain D of a transistor in the switch 1430, and an anode of each of the light-emitting elements 1440. The additional transistor 1480 may be referred to as an emitting control transistor. Referring to FIG. 14B, the compensation circuitry 1402 may include the compensation capacitor 1485. For example, the compensation capacitors 1485 (C2) may be connected to the gate G of the driving transistor 1410 and a drain D of the driving transistor 1410. Referring to FIG. 14C, the compensation circuitry 1403 may include the compensation capacitor 1485. For example, the compensation capacitor 1485 (C2) may be connected to the gate G of the driving transistor 1410, a drain D of the emitting control transistor 1420, and a source S of the transistor in the switch 1430.

Referring to FIGS. 14A to 14C, compensation circuitry for a sub-pixel may include a compensation capacitor for compensating for a luminance deviation. As a capacitance of the compensation capacitor is changed, luminance may be changed. An electronic device and a method according to an embodiment of the present disclosure may improve a luminance deviation in a plurality of sub-pixels included in a display panel by adjusting the capacitance of the compensation capacitor.

In FIGS. 14A to 14C, an example in which compensation circuitry includes one compensation capacitor is illustrated, but an embodiment of the present disclosure is not limited thereto. For example, the compensation circuitry may include a plurality of compensation capacitors and a transistor for the plurality of compensation capacitors. For example, the plurality of compensation capacitors may be selected by the transistor for the plurality of capacitors. For example, some or all of the plurality of compensation capacitors may be selected based on a control signal applied to the transistor for the plurality of capacitors. For example, DDI (e.g., the DDI 230 of FIG. 2) may identify a luminance deviation of the display panel (e.g., a display panel 210) and provide the control signal for a specific line or a specific sub-pixel to reduce the luminance deviation.

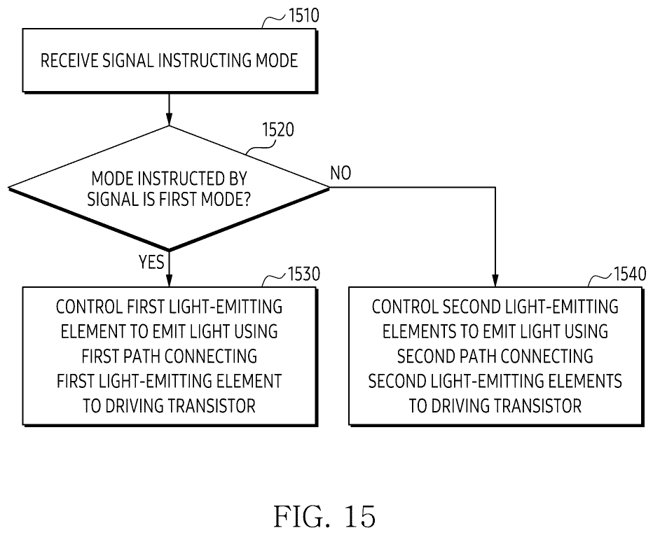

FIG. 15 illustrates an example of an operation flow for a method of selectively driving a light-emitting element in accordance with a mode.

The method of FIG. 15 may be performed by the display module 160 of FIG. 2. For example, at least one operation of the method may be controlled by the DDI 230 of the display module 160 of FIG. 2. For example, the DDI 230 may control compensating circuitry related to a sub-pixel in a display panel 210. For example, the compensation circuitry may include the compensation circuitry 505 of FIG. 5.

Referring to FIG. 15, in operation 1510, the DDI 230 may receive a signal instructing a mode. For example, the DDI 230 may receive the signal from a processor 120. For example, the mode may include a first mode for low power of the display panel 210 for displaying an image and a second mode different from the first mode. The second mode may be referred to as a normal mode or an active state mode. For example, the signal may instruct the first mode or the second mode.

For example, the DDI 230 may obtain an image. For example, the DDI 210 may obtain the image to be displayed in the first mode or the second mode from the processor 120. For example, the DDI 230 may identify a data voltage based on the image. For example, the DDI 230 may identify a bias voltage to minimize or reduce a difference from luminance based on the data voltage. For example, the DDI 230 may identify a variable anode reset (VAR) voltage to minimize the difference.

In operation 1520, the DDI 230 may identify whether the mode instructed by the signal is the first mode. For example, the DDI 230 may identify whether the mode is the first mode based on the signal obtained from the processor 120. In the operation 1520, in a case that the mode is the first mode, the DDI 230 may perform operation 1530. In contrast, in the operation 1520, in a case that the mode is the second mode, the DDI 230 may perform operation 1540.

In the operation 1530, the DDI 230 may control a first light-emitting element to emit light using a first path connecting the first light-emitting element to a driving transistor. For example, the DDI 230 may control the first light-emitting element to emit light using the first path in the first mode. For example, the first path may be a path formed through a switch (e.g., the switch 530 of FIG. 5) of compensation circuitry (e.g., the compensation circuitry 505 of FIG. 5). For example, a structure of the compensation circuitry may be referenced to as the compensation circuitry 505 of FIG. 5. For example, the compensation circuitry may include a plurality of transistors, the switch, and a plurality of light-emitting elements. For example, the plurality of light-emitting elements may include the first light-emitting element (e.g., the first light-emitting element 541 of FIG. 5) and second light-emitting elements (e.g., the second light-emitting elements 542 of FIG. 5).

For example, the DDI 230 may control the switch to form the first path based on a control signal. For example, the first path may be a path connecting a first transistor (e.g., the first transistor 531 of FIG. 5) in the switch, the driving transistor (e.g., the driving transistor 510 of FIG. 5), and the first light-emitting element. For example, the switch may include the first transistor connected to the first light-emitting element and a second transistor (e.g., a second transistor 532) connected to the second light-emitting elements different from the first light-emitting element. For example, the first transistor and the second transistor may be of different types. For example, the first transistor may include an N-type metal oxide semiconductor (NMOS) transistor. The second transistor may include a P-type metal oxide semiconductor (PMOS) transistor. For example, the control signal may have a voltage of a first value for driving (or turning on) the first transistor among the first transistor and the second transistor of the switch. However, an embodiment of the present disclosure is not limited thereto. For example, the switch 530 may include 3 transistors, as in the example of FIG. 9.

For example, in the first mode, the DDI 230 may control the first light-emitting element to emit light based on executing a first scan in accordance with a first time interval (e.g., the first time interval 351 of FIG. 3C) based on a data voltage for displaying the image or a second scan in accordance with a second time interval (e.g., the second time interval 352 of FIG. 3C) shorter than the first time interval based on a bias voltage for the driving transistor. For example, the first time interval may be related to a frame rate. For example, the second time interval may indicate a time interval between the first scan and the second scan, or between a plurality of second scans. For example, in the first mode, a degree of light emission to the outside of an electronic device 101 based on the first scan and the second scan may be related to a refresh rate.

For example, the first scan may be referred to as an address scan. For example, the second scan may be referred to as a self scanning. For example, the address scan may include initializing a gate G of the driving transistor, applying a data voltage to the initialized gate G, and providing a current to a light-emitting element (e.g., the first light-emitting element or the second light-emitting elements) through the driving transistor in which the data voltage is applied to the gate G. For example, unlike the address scan, the self scanning may include providing the current to the light-emitting element through the driving transistor from among initializing the gate G, applying the data voltage to the initialized gate G, and providing the current to the light-emitting element through the driving transistor.

Referring to the above description, in the first mode, the DDI 230 may control the first light-emitting element of the sub-pixel in the display panel 210 to emit light by controlling the switch based on the control signal. The DDI 230 controlling the first light-emitting element to emit light may indicate that the display panel 210 is controlled so that the first light-emitting element emits light.

In the operation 1540, the DDI 230 may control the second light-emitting elements to emit light using a second path connecting the second light-emitting elements to the driving transistor. For example, in the second mode, the DDI 230 may control the second light-emitting elements to emit light using the second path. For example, the second path may be a path formed through the switch of the compensation circuitry.

For example, the DDI 230 may control the switch to form the second path based on the control signal. For example, the second path may be a path connecting the second transistor in the switch, the driving transistor, and the second light-emitting elements. For example, the control signal may have a voltage of a second value different from the first value for driving (or turning on) the second transistor among the first transistor and the second transistor of the switch. However, an embodiment of the present disclosure is not limited thereto. For example, the switch 530 may include 3 transistors, as in the example of FIG. 9.

For example, in the second mode, the DDI 230 may control the second light-emitting elements to emit light based on executing the first scan in accordance with the first time interval (e.g., the first time interval 341 of FIG. 3C) based on the data voltage for displaying the image. For example, the first time interval may be related to a frame rate. For example, the first time interval in the second mode may correspond to the second time interval in the first mode.

Referring to the above description, in the second mode, the DDI 230 may control the second light-emitting elements of the sub-pixel in the display panel 210 to emit light by controlling the switch based on the control signal. The DDI 230 controlling the second light-emitting elements to emit light may indicate that the display panel 210 is controlled so that the second light-emitting elements emit light.

Although FIG. 15 is described based on the sub-pixel of the display panel 210, an embodiment of the present disclosure is not limited thereto. For example, the DDI 230 may provide the control signal to a switch of each of the plurality of sub-pixels included in the display panel 210. In other words, the DDI 230 may provide the control signal to all of the plurality of sub-pixels included in the display panel 210. For example, at least one scan signal for the first scan and the second scan may be provided for each of the plurality of lines (or scan lines) related to the plurality of sub-pixels.

In addition, in FIG. 15, a case that the compensation circuitry for the sub-pixel included in the display panel 210 is the compensation circuitry 505 of FIG. 5 is described as an example, but an embodiment of the present disclosure is not limited thereto. For example, the compensation circuitry may include the compensation circuitry 905 of FIG. 9 and the compensation circuitry 1401, 1402, and 1403 of FIGS. 14A to 14C. For example, in a case that the compensation circuitry is the compensation circuitry 905 of FIG. 9, the DDI 230 may control the switch including 3 transistors using the control signal. For example, based on the switch, the DDI 230 may control the first light-emitting element, which is a partial light-emitting element among the plurality of light-emitting elements, to emit light in the first mode, or may control all of the plurality of light-emitting elements to emit light in the second mode. In addition, for example, in a case that the compensation circuitry is the compensation circuitry 1401, 1402, and 1403 of FIGS. 14A to 14C, the compensation circuitry in the display panel 210 controlled by the DDI 230 may include a compensation capacitor to improve a luminance deviation. For example, the compensation capacitor may be connected to a driving transistor.

Referring to FIGS. 1 to 15, an electronic device and a method according to an embodiment of the present disclosure may include a switch for selecting a light-emitting element for light emission. The electronic device and the method according to an embodiment of the present disclosure may selectively drive a light-emitting element for light emission based on the switch. The electronic device and the method according to an embodiment of the present disclosure may selectively use a light-emitting element based on the switch in accordance with a mode (e.g., the second mode) for improving yield and providing maximum luminance and a mode (e.g., the first mode) for low power. In addition, the electronic device and the method according to an embodiment of the present disclosure may improve a luminance deviation by using a compensation capacitor.

As described above, an electronic device 101 may include a display panel 210 including a plurality of sub-pixels. The electronic device 101 may include a processor 120. The electronic device 101 may include display driver circuitry 230. Each of the plurality of the sub-pixels may include a first light-emitting element 541 emitting light in a first mode for low power and second light-emitting elements 542 emitting light in a second mode different from the first mode. Each of the plurality of the sub-pixels may include a driving transistor 510 to provide a current to the first light-emitting element 541 and the second light-emitting elements 542. Each of the plurality of the sub-pixels may include a switch 530 between a drain of the driving transistor 510 and the first light-emitting element 541 and the second light-emitting elements 542. The display driver circuitry 230 may be configured to receive, from the processor 120, a signal instructing a mode in which the display driver circuitry 230 drives. The display driver circuitry 230 may be configured to, in the first mode identified based on the signal, control the first light-emitting element 541 to emit light using a first path, which is formed based on the switch 530, connecting the first light-emitting element 541 to the driving transistor 510. The display driver circuitry 230 may be configured to, in the second mode identified based on the signal, control the second light-emitting elements 542 to emit light using a second path, which is formed based on the switch 530, connecting the second light-emitting elements 542 to the driving transistor 510.

According to an embodiment, the display driver circuitry 230 may be configured to, in response to identifying that the mode instructed by the signal is the first mode, provide a voltage of a first value to the switch 530 of each of the plurality of the sub-pixels. The display driver circuitry 230 may be configured to, in response to identifying that the mode instructed by the signal is the second mode, provide a voltage of a second value different from the first value to the switch 530 of each of the plurality of the sub-pixels.

According to an embodiment, the switch 530 may include a first transistor 531 and a second transistor 532 of a different type from the first transistor 531. The switch 530 may form the first path using the first transistor 531 based on a voltage of the first value. The switch 530 may form the second path using the second transistor 532 based on a voltage of the second value.

According to an embodiment, the first transistor 531 may include an N-type metal oxide semiconductor (NMOS) transistor. The second transistor 532 may include a P-type metal oxide semiconductor (PMOS) transistor.

According to an embodiment, the display driver circuitry 230 may be configured to obtain an image from the processor 120. The display driver circuitry 230 may be configured to, in the first mode, based on performing a first scan in accordance with a first time interval based on a data voltage for displaying the image or a second scan in accordance with a second time interval shorter than the first time interval based on a bias voltage for the driving transistor 510, control the first light-emitting element 541 to emit light.

According to an embodiment, the display driver circuitry 230 may be configured to obtain an image from the processor 120. The display driver circuitry 230 may be configured to, in the second mode, based on performing a first scan in accordance with a first time interval based on a data voltage for displaying the image, control the second light-emitting elements 542 to emit light.

According to an embodiment, the switch 530 may be connected to an anode of the first light-emitting element 541 and an anode of each of the second light-emitting elements 542.

As described above, an electronic device 101 may include a display panel 210 including a plurality of sub-pixels. The electronic device 101 may include memory including one or more storage media storing instructions. The electronic device 101 may include a processor 120. The electronic device 101 may include display driver circuitry 230. Each of the plurality of the sub-pixels may include a first light-emitting element 541 emitting light in a first mode for low power and second light-emitting elements 542 emitting light in a second mode different from the first mode. Each of the plurality of the sub-pixels may include a driving transistor 510 to provide a current to the first light-emitting element 541 and the second light-emitting elements 542. Each of the plurality of the sub-pixels may include a switch 530 between a drain of the driving transistor 510 and the first light-emitting element 541 and the second light-emitting elements 542. The instructions, when executed by the display driving circuitry 230, may cause the display driving circuitry 230 to receive, from the processor 120, a signal instructing a mode in which the display driver circuitry 230 drives. The instructions, when executed by the display driving circuitry 230, may cause the display driving circuitry 230 to, in the first mode identified based on the signal, control the first light-emitting element 541 to emit light using a first path, which is formed based on the switch 530, connecting the first light-emitting element 541 to the driving transistor 510. The instructions, when executed by the display driving circuitry 230, may cause the display driving circuitry 230 to, in the second mode identified based on the signal, control the second light-emitting elements 542 to emit light using a second path, which is formed based on the switch 530, connecting the second light-emitting elements 542 to the driving transistor 510.

According to an embodiment, the instructions, when executed by the display driving circuitry 230, may cause the display driving circuitry 230 to, in response to identifying that the mode instructed by the signal is the first mode, provide a voltage of a first value to the switch 530 of each of the plurality of the sub-pixels. The instructions, when executed by the display driving circuitry 230, may cause the display driving circuitry 230 to, in response to identifying that the mode instructed by the signal is the second mode, provide a voltage of a second value different from the first value to the switch 530 of each of the plurality of the sub-pixels.

According to an embodiment, the switch 530 may include a first transistor 531 and a second transistor 532 of a different type from the first transistor 531. The switch 530 may form the first path using the first transistor 531 based on a voltage of the first value. The switch 530 may form the second path using the second transistor 532 based on a voltage of the second value.

According to an embodiment, the first transistor 531 may include an N-type metal oxide semiconductor (NMOS) transistor. The second transistor 532 may include a P-type metal oxide semiconductor (PMOS) transistor.

According to an embodiment, the display driver circuitry 230 may cause the display driver circuitry 230 to obtain an image from the processor 120. The instructions, when executed by the display driving circuitry 230, may cause the display driving circuitry 230 to, in the first mode, based on performing a first scan in accordance with a first time interval based on a data voltage for displaying the image or a second scan in accordance with a second time interval shorter than the first time interval based on a bias voltage for the driving transistor 510, control the first light-emitting element 541 to emit light.

According to an embodiment, the instructions, when executed by the display driving circuitry 230, may cause the display driving circuitry 230 to obtain an image from the processor 120. The instructions, when executed by the display driving circuitry 230, may cause the display driving circuitry 230 to, in the second mode, based on performing a first scan in accordance with a first time interval based on a data voltage for displaying the image, control the second light-emitting elements 542 to emit light.

According to an embodiment, the switch 530 may be connected to an anode of the first light-emitting element 541 and an anode of each of the second light-emitting elements 542.

As described above, a display panel 210 may include a sub-pixel of the display panel 210. The sub-pixel may include a first light-emitting element 541. The sub-pixel may include second light-emitting elements 542. The sub-pixel may include a driving transistor 510 to provide a current to the first light-emitting element 541 and the second light-emitting elements 542. The sub-pixel may include an emitting control transistor 520 connected to a drain of the driving transistor 510. The sub-pixel may include a switch 530 including a first transistor 531 and a second transistor 531. The first transistor 531 may include a first source connected to a drain of the emitting control transistor 520, a first drain connected to an anode of the first light-emitting element 541, and a first gate. The second transistor 532 may include a second source connected to the drain of the emitting control transistor 520, a second drain connected to an anode of each of the second light-emitting elements 542, and a second gate connected to the first gate. A control signal for driving the switch 530 may be applied to the first gate and the second gate.

According to an embodiment, a path connecting the first transistor 531 based on the driving of the switch 530 to the first light-emitting element may be formed in response to the control signal, having a voltage of a first value, applied to the first gate and the second gate. A path connecting the second transistor 532 based on the driving of the switch 530 to the second light-emitting elements may be formed in response to the control signal, having a voltage of a second value different from the first value, applied to the first gate and the second gate.

According to an embodiment, the sub-pixel may further include a third transistor 550 to compensate for a voltage. The third transistor 550 may include a third source connected to the drain of the driving transistor 510, a third drain connected to a gate of the driving transistor 510, and a third gate to which a first scan signal is applied.

According to an embodiment, the sub-pixel may further include a fourth transistor 555 for bypassing a leakage current of the second light-emitting elements and a fifth transistor 560 for initializing. The fourth transistor 555 may include a fourth source connected to the drain of the emitting control transistor 520, a fourth drain connected to a fifth source of the fifth transistor 560, and a fourth gate to which a second scan signal is applied. The fifth transistor 560 may include the fourth drain, the fifth source, a fifth drain connected to the third drain, and a fifth gate to which a third scan signal is applied.

According to an embodiment, the emitting control transistor 520 may be a first emitting control transistor 520. The sub-pixel may further include a switching transistor 565 for providing a bias voltage or a data voltage of the sub-pixel and a second emitting control transistor 570. The switching transistor 565 may include a sixth source to which the data voltage and the bias voltage are applied, a sixth drain connected to a source of the driving transistor 510, and a sixth gate to which the second scan signal is applied. The second emitting control transistor 570 may include a seventh source with which a driving voltage is provided, a seventh drain connected to the source of the driving transistor 510 and the sixth drain, and a seventh gate to which an emission signal is applied. The seventh gate may be connected to a gate of the first emitting control transistor 520.

According to an embodiment, the sub-pixel may further include a capacitor 575 charged by the data voltage and the bias voltage. The capacitor 575 may be connected to the gate of the driving transistor 510, the third drain of the third transistor 550, and the fourth drain of the fifth transistor 560.

According to an embodiment, the switch 530 or 930 may further include a selecting transistor 933. The selecting transistor 933 may include a source connected to the second drain, a drain connected to the first drain, and a gate to which the control signal is applied. The source of the selecting transistor 933 may be connected to an anode of each of the second light-emitting elements 942. The drain of the selecting transistor 933 may be connected to an anode of the first light-emitting element 941.

According to an embodiment, a path connecting the first transistor 931 based on the driving of the switch 530 or 930 to the first light-emitting element may be formed in response to the control signal, having a voltage of a first value, applied to the first gate, the second gate, and the gate of the selecting transistor. A path connecting the second transistor 932 based on the driving of the switch 530 or 930 to the first light-emitting element 941 and the second light-emitting elements 942 may be formed in response to the control signal, having a voltage of a second value different from the first value, applied to the first gate, the second gate, and the gate of the selecting transistor 933.

According to an embodiment, the first transistor 931 may include an N-type metal oxide semiconductor (NMOS) transistor. The second transistor 932 may include a P-type metal oxide semiconductor (PMOS) transistor. The selecting transistor 933 may include a PMOS transistor.

According to an embodiment, the sub-pixel may further include a third emitting control transistor 1480 and a compensation capacitor 1485. The third emitting control transistor 1480 may include a source connected to a gate of the driving transistor 510, a drain connected to the compensation capacitor 1485, and a gate to which an emission signal is applied. The compensation capacitor 1485 may be connected to the drain of the third emitting control transistor 520, the anode of the first emitting control transistor 541, and an anode of each of the second light-emitting elements 542.

According to an embodiment, the sub-pixel may further include a compensation capacitor 1485. The compensation capacitor 1485 may connect a gate of the driving transistor 510 to the drain of the driving transistor 510.

According to an embodiment, the sub-pixel may further include a compensation capacitor 1495. The compensation capacitor 1485 may connect a gate of the driving transistor 510 to the drain of the emitting control transistor 520.

According to an embodiment, a capacitance of the compensation capacitor 1485 may be identified based on a luminance deviation between the first light-emitting element 541 and the second light-emitting elements 542.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element. Thus, for example, “connected” as used herein covers both direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120, comprising processing circuitry) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a display panel including a plurality of sub-pixels;
a processor comprising processing circuitry; and
display driver circuitry,
wherein each of the plurality of the sub-pixels includes:
a first light-emitting element configured to emit light in a first mode for low power and second light-emitting elements configured to emit light in a second mode different from the first mode, each of said light-emitting elements comprising an electrode;
a driving transistor configured to provide a current to the first light-emitting element and the second light-emitting elements;
a switch between at least a drain of the driving transistor and the first light-emitting element and the second light-emitting elements,
wherein the display driver circuitry is configured to:
receive, from the processor, a signal instructing a mode in which the display driver circuitry drives,
in the first mode identified based on the signal, control the first light-emitting element to emit light via a first path, which is formed based on the switch, connecting the first light-emitting element to the driving transistor, and
in the second mode identified based on the signal, control the second light-emitting elements to emit light via a second path, which is formed based on the switch, connecting the second light-emitting elements to the driving transistor, wherein the second path is different than the first path.

2. The electronic device of claim 1, wherein the display driver circuitry is configured to:
in response to identifying that the mode instructed by the signal is the first mode, provide a voltage of a first value to the switch of each of the plurality of the sub-pixels, and
in response to identifying that the mode instructed by the signal is the second mode, provide a voltage of a second value different from the first value to the switch of each of the plurality of the sub-pixels.

3. The electronic device of claim 2, wherein the switch includes a first transistor and a second transistor of a different type from the first transistor,
wherein the switch is configured to form the first path using the first transistor based on a voltage of the first value, and
wherein the switch is configured to form the second path using the second transistor based on a voltage of the second value.

4. The electronic device of claim 3, wherein the first transistor includes an N-type metal oxide semiconductor (NMOS) transistor,
wherein the second transistor includes a P-type metal oxide semiconductor (PMOS) transistor, and
wherein the switch is connected to an anode of the first light-emitting element and an anode of each of the second light-emitting elements.

5. The electronic device of claim 1, wherein the display driver circuitry is configured to:
obtain an image from the processor,
in the first mode, based on performing a first scan in accordance with a first time interval based on a data voltage for displaying the image and/or a second scan in accordance with a second time interval shorter than the first time interval based on a bias voltage for the driving transistor, control the first light-emitting element to emit light.

6. The electronic device of claim 1, wherein the display driver circuitry is configured to:
obtain an image from the processor,
in the second mode, based on performing a first scan in accordance with a first time interval based on a data voltage for displaying the image, control the second light-emitting elements to emit light.

7. The electronic device of claim 1, wherein the switch is connected to an anode of the first light-emitting element and an anode of each of the second light-emitting elements.

8. A display panel comprising:
a sub-pixel of the display panel including:
a first light-emitting element comprising an electrode;
second light-emitting elements comprising an electrode;
a driving transistor configured to provide a current to the first light-emitting element and the second light-emitting elements;
an emitting control transistor connected to a drain of the driving transistor; and
a switch including a first transistor and a second transistor,
wherein the first transistor includes a first source connected to a drain of the emitting control transistor, a first drain connected to an anode of the first light-emitting element, and a first gate,
wherein the second transistor includes a second source connected to the drain of the emitting control transistor, a second drain connected to an anode of each of the second light-emitting elements, and a second gate connected to the first gate, and
wherein the display panel is configured so that a control signal for driving the switch is applied to the first gate and the second gate.

9. The display panel of claim 8, wherein the display panel is configured so that:
a path connecting the first transistor based on the driving of the switch to the first light-emitting element is formed in response to the control signal, having a voltage of a first value, applied to the first gate and the second gate, and
a path connecting the second transistor based on the driving of the switch to the second light-emitting elements is formed in response to the control signal, having a voltage of a second value different from the first value, applied to the first gate and the second gate.

10. The display panel of claim 8, wherein the sub-pixel further includes a third transistor configured to compensate for a voltage,
wherein the third transistor includes a third source connected to the drain of the driving transistor, a third drain connected to a gate of the driving transistor, and a third gate to which a first scan signal is applied,

11. The display panel of claim 10, wherein the sub-pixel further includes a fourth transistor configured for bypassing a leakage current of the second light-emitting elements and a fifth transistor configured for initializing,
wherein the fourth transistor includes a fourth source connected to the drain of the emitting control transistor, a fourth drain connected to a fifth source of the fifth transistor, and a fourth gate to which a second scan signal is applied, and
wherein the fifth transistor includes the fourth drain, the fifth source, a fifth drain connected to the third drain, and a fifth gate to which a third scan signal is applied.

12. The display panel of claim 11, wherein the emitting control transistor is a first emitting control transistor,
wherein the sub-pixel further includes switching transistor for providing a bias voltage and/or a data voltage of the sub-pixel and a second emitting control transistor,
wherein the switching transistor includes a sixth source to which the data voltage and the bias voltage are to be applied, a sixth drain connected to a source of the driving transistor, and a sixth gate to which the second scan signal is to be applied,
wherein the second emitting control transistor includes a seventh source with which a driving voltage is to be provided, a seventh drain connected to the source of the driving transistor and the sixth drain, and a seventh gate to which an emission signal is to be applied,
wherein the seventh gate is connected to a gate of the first emitting control transistor.

13. The display panel of claim 12, wherein the sub-pixel includes a capacitor configured to be charged by the data voltage and the bias voltage, and
wherein the capacitor is connected to the gate of the driving transistor, the third drain of the third transistor, and the fourth drain of the fifth transistor.

14. The display panel of claim 8, wherein the switch further includes a selecting transistor,
wherein the selecting transistor includes a source connected to the second drain, a drain connected to the first drain, and a gate to which the controlling signal is to be applied,
wherein the source of the selecting transistor is connected to an anode of each of the second light-emitting elements, and
wherein the drain of the selecting transistor is connected to an anode of the first light-emitting element.

15. The display panel of claim 14, wherein the display panel is configured so that:
a path connecting the first transistor based on the driving of the switch to the first light-emitting element is formed in response to the control signal, having a voltage of a first value, applied to the first gate, the second gate, and the gate of the selecting transistor, and
a path connecting the second transistor based on the driving of the switch to the first light-emitting element and the second light-emitting elements is formed in response to the control signal, having a voltage of a second value different from the first value, applied to the first gate, the second gate, and the gate of the selecting transistor.

16. The display panel of claim 14, wherein the first transistor includes an N-type metal oxide semiconductor (NMOS) transistor,
wherein the second transistor includes a P-type metal oxide semiconductor (PMOS) transistor, and
wherein the selecting transistor includes a PMOS transistor.

17. The display panel of claim 8, wherein the sub-pixel further includes a third emitting control transistor and a compensation capacitor,
wherein the third emitting control transistor includes a source connected to a gate of the driving transistor, a drain connected to the compensation capacitor, and a gate to which an emission signal is to be applied, and
wherein the compensation capacitor is connected to the drain of the third emitting control transistor, the anode of the first light-emitting element, and an anode of each of the second light-emitting elements.

18. The display panel of claim 8, wherein the sub-pixel further includes a compensation capacitor, and
wherein the compensation capacitor connects a gate of the driving transistor to the drain of the driving transistor.

19. The display panel of claim 8, wherein the sub-pixel further includes a compensating capacitor,
wherein the compensating capacitor connects a gate of the driving transistor to the drain of the emitting control transistor.

20. The display panel of claim 17, wherein a capacitance of the compensating capacitor is identified based on a luminance deviation between the first light-emitting element and the second light-emitting
